(19) United States
(12) Patent Application Publication
(10) Pub. No.: US 2024/0065308 A1
(43) Pub. Date: Feb. 29, 2024

(54) ILLUMINATION ROASTING

(71) Applicant: Optical Roasting Technologies, Inc., Dover, DE (US)

(72) Inventors: Matthew J. SCHURMAN, Dover, DE (US); Richard STALL, Dover, DE (US); Aaron SCHURMAN, Dover, DE (US)

(73) Assignee: Optical Roasting Technologies, Inc., Dover, DE (US)

(21) Appl. No.: 18/454,215

(22) Filed: Aug. 23, 2023

Related U.S. Application Data
(60) Provisional application No. 63/373,283, filed on Aug. 23, 2022.

(51) Int. Cl. A23N 12/12; A23N 12/08; G01J 3/28; G01J 5/48; G06T 7/90

(52) U.S. Cl. CPC A23N 12/125; A23N 12/083; G01J 3/2823; G01J 5/485; G06T 7/90; G06T 2207/10024; G06T 2207/30128

(57) ABSTRACT

Disclosed herein are system, method, and computer program product embodiments for illumination roasting. A lighting attribute may be determined based on an indication that a food product is within a chamber and a type of the food product. Based on an illumination of the food product according to the lighting attribute (e.g., a wavelength value, a lumens value, a wattage value, etc.), a change to the temperature profile of the food product may occur. The change in the temperature profile operates to roast the food product.

### CROSS REFERENCE TO RELATED APPLICATION

This application claims the benefit of U.S. Provisional Application No. 63/373,283, filed on Aug. 23, 2022.

### BACKGROUND

Over 2 billion cups of coffee are consumed worldwide, every day. Coffee is a drink that is brewed from coffee beans, which are the seeds of the coffee tree. To make coffee suitable for consumption, green coffee beans are roasted and grounded before brewing. Coffee roasting is a complex chemical process where raw, green coffee beans are heated to produce caramelization of the beans via the non-enzymatic browning process of a Maillard reaction. The Maillard reaction results in the formation of a diverse range of aromatic and color compounds, as well as compounds broadly labeled as Advanced Glycation End Products (or AGE) all of which contribute to the color, smell, taste, and nutritional content of the final food product. Coffee roasts are broken down into three broad categories (e.g., light roast, medium roast, dark roast) with each category reflecting different stopping points along the Maillard reaction chain—thus leading to different broadly distinct flavor profiles.

The amount of time associated with a roast of a coffee bean is routinely varied according to factors including, but not limited to, a type of roaster used, the temperature of the roast, the moisture content of used coffee beans, the amount of air flowing through the roaster, and humidity. Due to these factors, as well as the variability in the types of coffee beans available, roasting processes require skilled labor to monitor every roasting step. Thus, roasting processes are highly labor-intensive processes with an inability to effectively control variability in the flavor and quality of any resulting product.

Coffee roasters come in a wide variety of sizes and styles but routinely use two methods of roasting: a drum method and a fluid bed method. In the drum method the green coffee beans are placed in a rotating drum that is heated (e.g., via gas, wood, or electricity) and the heat is transferred to the coffee beans via direct conduction and/or convection. In the fluid bed method, the green coffee beans are placed in a chamber into which hot air is forced. The fluid bed method uses forced air to cause coffee beans to churn, and the heat is transferred primarily through convection. Fluid bed roasters tend to roast more quickly than drum-based roasters. Both the drum method and the fluid bed method routinely result in over and/or under-roasted coffee beans due to the inability to effectively monitor and control the Maillard reaction.

Moreover, coffee beans roasted with conventional roasting processes generate carbon dioxide gas internally that adversely affects the flavor of the resulting coffee product. For better taste, coffee beans roasted with conventional roasting processes must be degassed before being ground and consumed. Degassing of carbon dioxide routinely takes at least a day (e.g., 24 hours, etc.) and can vary depending on the type of coffee and roast. Roasting processes are unable to provide a “roast-to-cup” experience where green coffee beans are roasted and are immediately ready to be brewed and consumed with optimal taste—affecting the taste and/or enjoyability of coffee roasted by existing processes for an end user.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIGS. 1A-1B shows an example system for illumination roasting, according to some aspects.

FIG. 2 shows an example system for training an imaging module that may be used for illumination roasting, according to some aspects.

FIG. 3 shows a flowchart of an example training method for generating a machine learning classifier to classify data used for illumination roasting, according to some aspects.

FIG. 4 shows a flowchart of an example method for illumination roasting, according to some aspects.

FIG. 5 shows a flowchart of an example method for illumination roasting, according to some aspects.

FIG. 6 shows a schematic block diagram of an exemplary computer system in which aspects described may be implemented.

FIGS. 7A-7B shows example results of illumination roasting a food product and the depth of penetration of the food product when illuminated with light at different wavelengths.

FIG. 8 shows an example summary of illumination roasting a food product and depth penetration tests at different wavelengths.

FIG. 9 shows an example output of a sensing device used during an illumination roasting process.

### DETAILED DESCRIPTION

Provided herein are example systems, apparatuses, devices, methods, computer program product embodiments, and/or combinations and sub-combinations thereof for illumination roasting. The systems, apparatuses, devices, methods, computer program product embodiments, and/or combinations and sub-combinations thereof for illumination roasting provide a novel approach to food product roasting that utilizes controlled illumination via a light source, controlled pressure surrounding a food product, and optical/image data to roast a food product. For example, According to some aspects of this disclosure, green coffee beans (e.g., unroasted coffee beans, etc.) may be controllably heated in a vacuum chamber via illumination from a high irradiance light source (e.g., laser, light-emitting diode (LED), lamp, etc.). As described herein, roasting a food product in a vacuum enables control over the roasting process and end flavor result of the food product, while using optical heating to overcome limitations of convective heating (e.g., inability to use convection heating in a vacuum, etc.).

According to some aspects of this disclosure, the systems, apparatuses, devices, methods, computer program product embodiments, and/or combinations and sub-combinations thereof for illumination roasting utilize sensor (e.g., optical sensors, pressure transducers, etc.) data, machine learning, computer vision, and/or automated indicators for the detection of stages and/or states of a food product (e.g., first and/or second crack stages of a coffee bean which signify the progression of a roast, etc.). For example, According to some aspects of this disclosure, the systems, apparatuses, devices, methods, computer program product embodiments, and/or combinations and sub-combinations thereof for illumination roasting using optical imaging to monitor attributes of a food product (e.g., the color of coffee beans, etc.) at different wavelengths and/or intensities, and a specially trained predictive model to characterize and optimize roasting of the food product. For example, according to some aspects of this disclosure, optical pyrometry may be used to measure, identify, and/or characterize a temperature profile (e.g., temperatures indicated at different depth levels, etc.) of a food product during a roasting process. According to some aspects of this disclosure, the moisture content of a food product may be measured, identified, and/or characterized based on information received from a pressure sensor for an enclosed chamber within which a food product is roasted. For example, a measure of the moisture of originally unroasted beans may be determined during a roasting process based on pressure measurements compared to temperature readings (e.g., the higher a determined pressure is in comparison to a determined temperature may indicate a higher moisture content of a food product, etc.).

According to some aspects of this disclosure, the systems, apparatuses, devices, methods, computer program product embodiments, and/or combinations and sub-combinations thereof for illumination roasting utilize high irradiance light sources (e.g., light-emitting diodes (LED), etc.) to enable roasting of a food product under vacuum (e.g., approximately 10 Torr, etc.) within the molecular flow regime.

According to some aspects of this disclosure, the systems, apparatuses, devices, methods, computer program product embodiments, and/or combinations and sub-combinations thereof for illumination roasting output a roasted food product including, but not limited to, coffee beans, with significantly less acrylamide content than existing roasting processes. Acrylamide is a substance that forms through a natural chemical reaction between sugars and asparagine, an amino acid, in plant-based foods (e.g., coffee beans, potatoes, cereal-grain-based foods, etc.). Acrylamide forms during high-temperature cooking, such as frying, roasting, and baking. Acrylamide is considered to be unhealthful for human consumption. By controlling the pressure with an enclosed roasting chamber, the systems, apparatuses, devices, methods, computer program product embodiments, and/or combinations and sub-combinations thereof for illumination roasting limit acrylamide from being accumulated in a roasted food product.

According to some aspects of this disclosure, the systems, apparatuses, devices, methods, computer program product embodiments, and/or combinations and sub-combinations thereof for illumination roasting enable roasting of a food product including, but not limited to, raw beans and/or the like, faster for a reduced cycle (e.g., period between a food product being in a raw and being in a state suitable for consumption, a roast-to-cup timeframe, etc.) time. A reduced cycle time for a food product including, but not limited to, raw beans and/or the like, facilitates reduced manufacturing costs for the food product. For example, the systems, apparatuses, devices, methods, computer program product embodiments, and/or combinations and sub-combinations thereof for illumination roasting enable high-quality roasting of a food product including, but not limited to, raw beans and/or the like in under ten minutes, while conventional systems have great cycle times (e.g., 10+ minutes, etc.).

According to some aspects of this disclosure, the systems, apparatuses, devices, methods, computer program product embodiments, and/or combinations and sub-combinations thereof for illumination roasting reduce the degree of human intervention associated with conventional roasting systems. For example, with conventional roasting systems, a user must monitor the roasting operation throughout the process to ensure that the roasted food product is not burned and/or is roasted according to intended states/conditions (e.g., first crack, second crack, light roast, dark roast, etc.). The systems, apparatuses, devices, methods, computer program product embodiments, and/or combinations and sub-combinations thereof for illumination roasting utilize specialized sensing devices and machine learning to automate a roasting process where a food product is not burned and/or is roasted according to intended states/conditions (e.g., first crack, second crack, light roast, dark roast, etc.).

According to some aspects of this disclosure, the systems, apparatuses, devices, methods, computer program product embodiments, and/or combinations and sub-combinations thereof for illumination roasting is scalable in size and/or may be implemented for roasting any amount of a food product (e.g., a large/industrial amount of coffee beans, a small/personal amount of coffee beans for consumption in a home or coffee shop setting, etc.). For example, according to some aspects of this disclosure, the systems, apparatuses, devices, methods, computer program product embodiments, and/or combinations and sub-combinations thereof for illumination roasting enable a “roast-to-cup” experience where green coffee beans are roasted and are immediately ready to be brewed and consumed with optimal taste, and/or a “just-in-time” experience where a user can receive quality roasted coffee beans at the time they are desired rather than buying a large quantity of roasted beans that must be consumed within a predefined period (e.g., a few weeks, etc.) before optimal flavor is lost.

According to some aspects of this disclosure, the systems, apparatuses, devices, methods, computer program product embodiments, and/or combinations and sub-combinations thereof for illumination roasting may selectively affect the flavor of a food product including, but not limited to, coffee beans and/or the like through the control of moisture content, temperature profile, and/or the like of the food product during a roasting process. According to some aspects of this disclosure, the systems, apparatuses, devices, methods, computer program product embodiments, and/or combinations and sub-combinations thereof for illumination roasting may be coupled with fine grinding of a food product to enable the food product to be consumed with optimal flavor (e.g., reduced bitterness, etc.) and/or in controlled portions. According to some aspects of this disclosure, optimal flavoring indicated by a lack of bitterness for fine ground coffee beans reduces any need to discard roasted coffee beans that are “outside an acceptable window” of optimal consumption. Therefore, users (e.g., baristas, etc.) of the systems, apparatuses, devices, methods, computer program product embodiments, and/or combinations and sub-combinations thereof for illumination roasting require less training to produce quality coffee-based products. Furthermore, the systems, apparatuses, devices, methods, computer program product embodiments, and/or combinations and sub-combinations thereof for illumination roasting can make full automation of high-quality coffee-based products more straightforward and cost-effective. Coffee beans roasted according to the systems, apparatuses, devices, methods, computer program product embodiments, and/or combinations and sub-combinations thereof for illumination roasting have a lower bitterness when brewed into expresso or coffee. This lower bitterness results from roasting under a vacuum and the enhanced outgassing of chemicals. Coffee beans may be brewed with a much wider window for acceptable bitterness. The systems, apparatuses, devices, methods, computer program product embodiments, and/or combinations and sub-combinations thereof for illumination roasting may roast food products such as coffee beans faster (e.g., less than five minutes, etc.) than conventional roasters or other devices while maintaining a taste and/or quality level of the food product. These and other technological advantages are described herein.

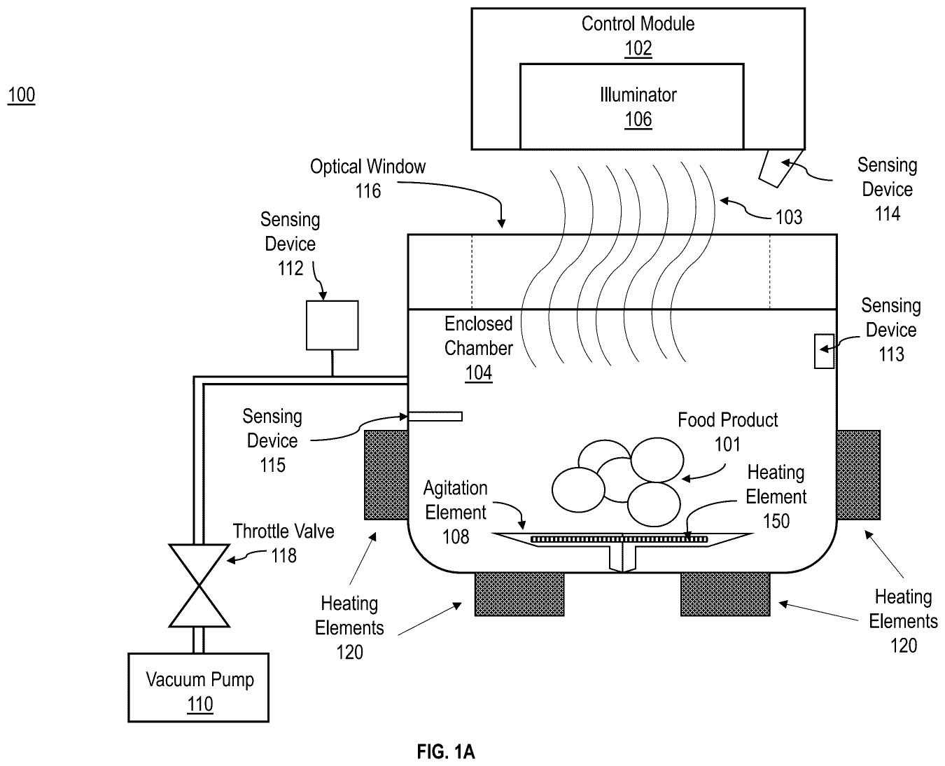

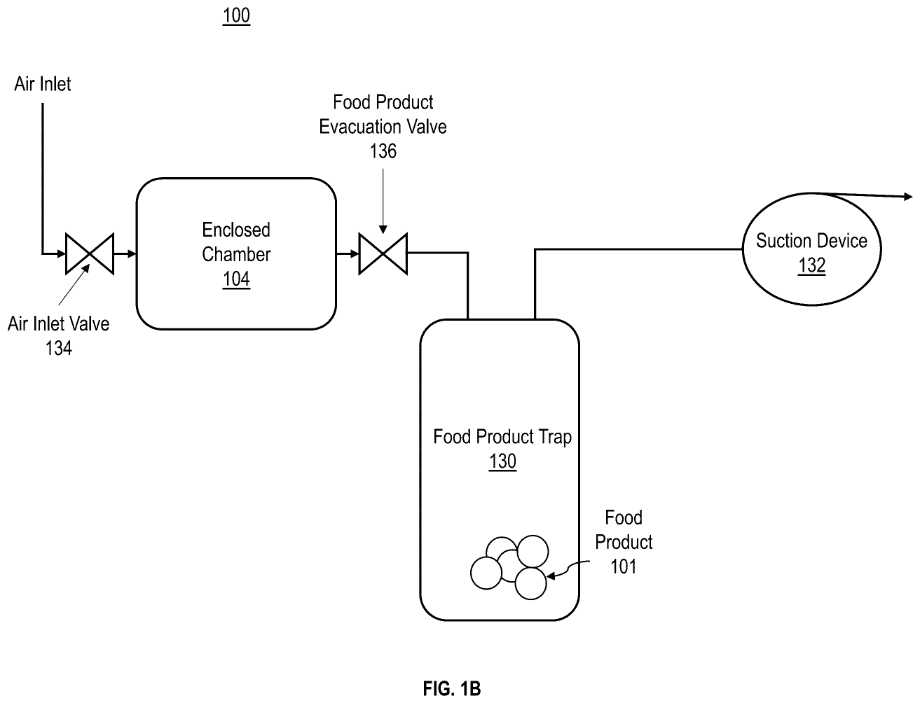

FIG. 1A shows a block diagram of an example system 100 for illumination roasting, according to some aspects. System 100 is merely an example of one suitable system environment and is not intended to suggest any limitation as to the scope of use or functionality of aspects described herein. Neither should the system 100 be interpreted as having any dependency or requirement related to any single device, module, component, and/or combinations thereof described therein. According to some aspects of this disclosure, system 100 may include a control module 102, an enclosed chamber 104, an illuminator 106, and an agitation element 108. Although multiple components are shown in system 100 to facilitate a roasting process for a food product, it will be appreciated that system 100 may operate to facilitate a roasting process for a food product via the use of more or fewer components of system 100.

According to some aspects of this disclosure, the control module 102 (e.g., a controller, a processor, a control device, etc.) may include any hardware, software, and/or combinations thereof, for communicating with and/or controlling operations of components of the system 100 including, but not limited to, the illuminator 106, the agitation element 108, a vacuum pump 110, sensing devices 112-114, a throttle valve 118, and/or heating elements 120.

According to some aspects of this disclosure, the control module 102 may include and/or be in communication with one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, interaction with the input devices and/or components may enable a user to set parameters (e.g., illumination/lighting attributes, roasting time, food product identifiers, temperature settings, chamber pressure settings, etc.) for a roasting process, view/obtain a status of a roasting process, and/or interact with and control devices/components of the system 100.

According to some aspects of this disclosure, the control module 102 may include one or more processors, machine learning models, and/or the like for managing operations of the system 100 including, but not limited to illumination-based roasting processes and/or the like. According to some aspects of this disclosure, control module 102 may manage and/or control a roasting process for a food product according to a processing profile. The control module 102 may include and/or be in communication with a storage element that stores any number of processing profiles. A processing profile may indicate parameters for roasting a particular food product, for example, such as a green coffee bean and/or the like. For example, a process profile for a food product may define: the temperature at which a food product is to be heated for optimal roasting, wavelength and/or intensity information for light applied to a food product to achieve a specified result, expected chemical reactions and/or gasses produced for a food product during a roasting process, image/acoustic indicators for identifying stages of a food product, roasting intervals and other time-related data, and/or the like. According to some aspects of this disclosure, processing profiles may be pre-configured and/or stored by the control module 102 or may be customized and/or generated according to data/information received from a user (e.g., via a user interface, etc.).

According to some aspects of this disclosure, the enclosed chamber 104 may be constructed of a sturdy material including, but not limited to, stainless steel, aluminum, ceramic, and/or the like. According to some aspects of this disclosure, the enclosed chamber 104 may be a vacuum chamber. According to some aspects of this disclosure, the enclosed chamber 104 may be air and/or leak-tight, for example, with pressures within the enclosed chamber 104 measuring below 10⁻³ torr when empty. According to some aspects of this disclosure, a food product 101 may be placed in the enclosed chamber 104 for roasting. According to some aspects of this disclosure, the food product may include green (unroasted) coffee beans, fish, vegetables, legumes, meat, beans, grains, and/or the like. Food product 101 may be any food product, product, item, and/or the like. According to some aspects of this disclosure, the enclosed chamber 104 and/or the food product 101 may be heated via illumination from an illuminator 106. For example, the control module may control the operation of the illuminator 106 to cause light of varying wavelengths and/or intensities to permeate through the enclosed chamber 104 and heat/roast the food product 101.

According to some aspects of this disclosure, the illuminator 106 may include, but is not limited to, an array of light-emitting diodes (LEDs), a laser, laser diodes, incandescent lamps, metal halide lamps, arc lamps, infrared emitters, and/or the like. According to some aspects of this disclosure, the illuminator 106 may operate according to one or more lighting attributes for a food product indicated in a processing profile. A lighting attribute may include, but is not limited to a wavelength value, a lumens value, a wattage value, an intensity level, a lighting duration/amount of time, and/or the like. According to some aspects of this disclosure, the illuminator 106 may output an array of wavelengths selected based on the amount of heat transfer they provide according to the optical absorption properties of the food product 101 and the depth of penetration of the wavelength.

According to some aspects of this disclosure, to optimize any roasting process, wavelengths of light 103 output by the illuminator 106 may be selected by the control module 102. For example, the control module 102 may include a machine learning model trained to select lighting attributes and/or wavelengths to be output by the illuminator 106 during a roasting process to affect the depth of roast/heating of a food product. According to some aspects of this disclosure, the control module 102 may select lighting attributes and/or wavelengths to be output by the illuminator 106 according to attributes of a food product within or to be placed within the enclosed chamber 104. For example, to optimize a coffee roasting process, the illuminator 106 may output wavelengths (e.g., at least 450 nm) with high surface absorption into a coffee bean. The illuminator 106 may output wavelengths with significant optical penetration of a coffee bean (e.g., 940 nm, etc.).

As described in detail later herein, according to some aspects of this disclosure, the control module 102 may select lighting attributes and/or wavelengths to be output by the illuminator 106 according to data/information received from various components of the system 100 including, but not limited to, the sensing devices 112-114.

According to some aspects of this disclosure, a top portion of the enclosed chamber 104 may include and/or be sealed with an optical window 116 that enables optical access and/or light 103 to permeate through the entire interior of the enclosed chamber 104. According to some aspects of this disclosure, the optical window 116 may include a heating element (not shown) that may be controlled by the control module 102 to heat the optical window 116. According to some aspects of this disclosure, heating the optical window 116 may prevent and/or mitigate condensation of water and/or other outgassed products (e.g., emitted from the food product 101, etc.) from a roasting process from accumulating on the enclosed chamber 104 and ensure consistent optical access and/or illumination of the food product 101. At the bottom of the chamber is a mixing blade that is affixed to a vacuum-compatible rotary feedthrough. This blade turns the bed of the beans during the roasting process.

According to some aspects of this disclosure, the enclosed chamber 104 may include an agitation element 108. According to some aspects of this disclosure, agitation element 108 may include a mixing blade attached to a shaft that is connected to a vacuum-compatible rotary feedthrough. According to some aspects of this disclosure, the rate and direction of rotation of the agitation element 108 may be varied by the control module 102 (e.g., either via an instruction received via the control module 102 or based on one or more instructions/outputs of the machine learning model of the control module 102, etc.). For example, during the roasting of coffee beans within the enclosed chamber 104, the agitation element 108 may operate at a rotation speed of approximately 120 RPM, but the rate may be varied to optimize a roasting process and/or to prevent the charring of a food product. According to some aspects of this disclosure, a rate of operation of the agitation element 108 may be based on the size of the enclosed chamber 104 and/or the volume of the food product 101. According to some aspects of this disclosure, the agitation element 108 may operate to continuously turn over the food product 101 to ensure that each portion of the food product 101 (e.g., each coffee bean, etc.) is roasted evenly and each portion of the food product 101 is exposed to illumination from the illuminator 106 for the same amount of time during a roasting process.

According to some aspects of this disclosure, agitation element 108 may include different mixing elements and/or operations. For example, the agitation element 108 may include a blade, a paddle, a wire, and/or any movable object that can be controllably operated via the control module 102 and withstand high roasting temperatures and/or various pressure conditions within the enclosed chamber 104. According to some aspects of this disclosure, the agitation element 108 may be a vibratory element that causes the food product 101 to orient such that each portion of the food product 101 is exposed to light 103 via the optical window 116.

According to some aspects of this disclosure, the food product 101 within the enclosed chamber may (optionally) further be heated via one or more heating elements 120. According to some aspects of this disclosure, the heating elements 120 may be resistance heaters positions along the baseplate and lower walls of the enclosed chamber 104. One or more heating elements 120 may be operated at temperature ranges from 20-350° C.

As described, According to some aspects of this disclosure, the enclosed chamber 104 may be a vacuum chamber. According to some aspects of this disclosure, the system 100 may include a vacuum pump 110. The vacuum pump 110 may be controlled by the control module 102 and operated to pump air from the inside of the enclosed chamber 104 to generate and/or maintain a vacuum pressure state within the enclosed chamber 104 during a roasting process. According to some aspects of this disclosure, as a food product (e.g., the food product 101, etc.) is heated within the enclosed chamber 104 by illumination from the illuminator 106, heated water, oils, and other materials may be emitted (e.g., outgassed, etc.) from the food product and cause the pressure level within the enclosed chamber to increase. The vacuum pump 110 may be used to regulate pressures within the enclosed chamber 104 during a roasting process.

According to some aspects of this disclosure, the vacuum pump 110 may operate without oil (e.g., is oilless, etc.) to prevent contamination of food products during a roasting process. According to some aspects of this disclosure, the vacuum pump 110 may be operated to achieve a base pressure in the enclosed chamber 104 of at least less than 1 torr whenever a food product is within the enclosed chamber during a roasting process. According to some aspects of this disclosure, system 100 may include a throttling valve 118 connected to the vacuum pump 110 to regulate the rate at which pressure is increased/decreased within the enclosed chamber 104.

According to some aspects of this disclosure, system 100 may include the sensing device 112. The sensing device may be, for example, one or more vacuum pressure transducers, pressure sensors (e.g., strain gauge, variable capacitance, solid-state, micromachined silicon (MMS), etc.), capacitance manometers, and/or the like. The sensing device 112 may be used to detect and/or monitor the pressure in the enclosed chamber 104 during different phases of a roasting process. According to some aspects of this disclosure, the sensing device 112 detects and/or monitors the pressure in the enclosed chamber 104 independent of any gas constituents in the enclosed chamber 104. One example of this type of transducer is a Capacitance Manometer.

According to some aspects of this disclosure, the sensing device 112 may send pressure measurements for the enclosed chamber 104 to the control module 102 and the control module may use the pressure measurements and/or related information to control the operation of the vacuum pump 110 and/or the throttle valve 118 to regulate the pressure level within the enclosed chamber 104. For example, the sensing device 112 may send the control module 102 pressure-related information that may signify: the moisture content of a food product in the enclosed chamber 104, the onset, and duration, of a “first crack” scenario for a coffee bean food product (which indicates a roast level for the coffee bean), the onset of a “second crack” scenario for a coffee bean food product (which indicates a dark roast level for the coffee bean), and/or the like. For example, at about 200-220° C. (392-428° F.), originally unroasted coffee beans emit a cracking sound commonly referred to as the “first crack,” marking the beginning of a light roast. When coffee beans are at about 224-245° C. (435-473° F.), they emit a “second crack.” During the first and second “cracks,” pressure inside the bean has increased to the point where the structure of the bean fractures, rapidly releasing gases, thus an audible sound is emitted. By detecting and identifying these pressure changes of coffee beans within the enclosed chamber 100, the roast state of the coffee beans may be identified.

For example, According to some aspects of this disclosure, air may be removed from the enclosed chamber 104 via the vacuum pump 110 to achieve a base and/or set pressure level (e.g., a user-defined base pressure level, an artificial intelligence-determined base pressure level, etc.). According to some aspects of this disclosure, a base pressure level may correspond to the outgassing rate of a food product (e.g., coffee beans, food product 101, etc.) during initial heating. As pressure levels within the enclosed chamber rise, the rate of change may be used to optimize the roast by indicating a need for more or less optical power and/or illumination from the illuminator 106 to compensate for higher or lower moisture content of the food product (e.g., coffee beans, the food product 101, etc.).

According to some aspects of this disclosure, system 100 may (optionally) include the sensing device 113. According to some aspects of this disclosure, the sensing device 113 may be and/or include a microphone and/or the like. The sensing device 113 may detect a sound level (e.g., an amplitude level, a frequency, etc.) and/or an amount of acoustic energy emitted from the enclosed chamber 104 during a roasting process. The sensing device 113 may send data/information indicative of a sound level and/or an amount of acoustic energy emitted from the enclosed chamber 104 to the control module 102. According to some aspects of this disclosure, control module 102 may determine if the measured acoustic energy is within a tolerance of the processing profile for a food product. A processing profile for a food product may include reference acoustical characteristics of a roasting process for the food product. For example, acoustical characteristics may indicate a sound level and/or an amount of acoustic energy emitted during cracking stages (e.g., first crack, second crack, etc.) of a coffee bean and/or the like. The control module 102 may use acoustical indications of a roasting process to control lighting attributes of the illuminator 106, an agitation rate of the agitation element 108, a pressure level induced by the vacuum pump 110, and/or the like.

According to some aspects of this disclosure, system 100 may include the sensing device 114. According to some aspects of this disclosure, the sensing device 114 may be and/or include an optical pyrometer, an infrared imaging device, a high-definition imaging device, a colorimeter, a hyperspectral imaging device, and/or the like. According to some aspects of this disclosure, the sensing device 114 may measure the temperature of a food product (e.g., coffee bean, etc.) during a roasting process. For example, According to some aspects of this disclosure, the sensing device 114 may include an optical pyrometer. The optical pyrometer may measure, detect, identify, and//or determine the emissivity of a food product within the enclosed chamber 104 during a roasting process.

According to some aspects of this disclosure, the sensing device 114 may include an imaging device including, but not limited to, a high-definition camera and/or the like. The sensing device 114 may be placed to enable part, or all, of the enclosed chamber 104 to be imaged through the optical window 116. According to some aspects of this disclosure, the sensing device 114 may include one or more optical filters (e.g., high pass filters, low pass filters, bandpass filters, etc.) that filter out and/or eliminate the perception of light from the illuminator 106. Image data of a food product inside the enclosed chamber 104 may be analyzed by the control module 102 to identify the state of the food product during a roasting process. For example, According to some aspects of this disclosure, an amount of optical power reflected by a food product at different wavelengths can be assessed, determined, and/or identified by a measure of luminance, brightness, and/or intensity depicted by image data. Images and/or image data indicative of a food product when varying wavelengths of light are applied to the food product may be analyzed by the control module 102 to determine a roasting level and/or state of a food product and cause variation of the intensity illumination by the illuminator 106 to optimize a roasting process.

According to some aspects of this disclosure, illuminator 106 may include a coherent source of light (e.g., a laser, laser diode, etc.). Data/information indicative of the optical scatter of light from a food product may be detected, determined, and/or identified by the sensing device 114 and provided the control module 102 for optical speckle analysis. As a food product such as coffee beans is heated by light from the illuminator within the vacuum-pressured enclosed chamber 104, the food product will begin to produce, output, and/or evolve oils that coat the surface of the coffee beans—causing a change in the surface roughness/texture of the coffee beans. The change in surface roughness/texture of the coffee beans may be identified via optical speckle analysis and used to classify the state of the coffee beans during a roasting process. For example, for coffee beans in a dark roast state, a greater amount of produced, output, and/or evolved oils may be detected, determined, and/or identified on the surface of the coffee beans.

According to some aspects of this disclosure, at the start of a roasting process, the enclosed chamber 104 may be in an empty state, open to the atmosphere, and preheated (via the heating elements 120, etc.) to a temperature preset. The preset temperature may vary according to the type of food product roasted in the enclosed chamber 104. Before placing a food product such as unroasted coffee beans may be placed inside the enclosed chamber 104, an agitation rate of the agitation element 108 may be set and initiated, for example, via the control module 102. For example, the agitation element 108 may be a mixing blade and the rotation rate of the mixing blade may be set to a low speed (e.g., approximately 1 RPM, etc.). According to some aspects of this disclosure, a food product such as unroasted coffee beans may be placed inside the enclosed chamber 104. Agitation of the coffee beans by the agitation element 108 may cause the coffee beans to spread throughout the enclosed chamber 104 and prevent the coffee beans from scorching on the heated walls of the enclosed chamber 104 while at atmospheric pressure.

According to some aspects of this disclosure, placing a food product such as unroasted coffee beans may be placed inside the enclosed chamber 104 may be performed manually by a user. For example, a user may place coffee beans in the enclosed chamber 104 by opening the optical window or via a side port in the enclosed chamber 104 (not shown). According to some aspects of this disclosure, placing a food product such as unroasted coffee beans may be placed inside the enclosed chamber 104 may be performed via an automated hopper (not shown) that may be attached to the enclosed chamber 104 through a side port (not shown). According to some aspects of this disclosure, an automated hopper may be multiplexed with other hoppers—each with different types of food products (e.g., types/varieties of coffee beans, etc.) enabling an automated loading and selection of various food products.

According to some aspects of this disclosure, once a food product such as unroasted coffee beans may is placed inside the enclosed chamber 104, the vacuum pump 110 may be operated to remove air from the enclosed chamber 104. The enclosed chamber 104 may be pumped down to a user-desired vacuum level and agitation of the agitation element 108 may be set to a high rate (e.g., >2 RPM, etc.) to ensure rapid and continuous mixing of the food product inside the enclosed chamber 104.

According to some aspects of this disclosure, agitation element 108 may (optionally) include heating element 150. The heating element 150 may generate, radiant heat that is transferred via the agitation element 108 to the food product 101. According to some aspects of this disclosure, the temperature of heating element 150 may be controlled and/or modified via instructions from the control module 102. Heating element 150 may generate heat of any temperature, such as temperature ranges from 20-350° C.

According to some aspects of this disclosure, system 100 may (optionally) include sensing device 115. According to some aspects of this disclosure, sensing device 115 may measure the temperature of a food product (e.g., coffee bean, etc.) and/or of enclosed chamber 104 during a roasting process. For example, the sensing device 115 may be and/or include a temperature probe, a thermocouple probe, and/or the like. For example, a measuring junction of sensing device 115 may be near and/or in contact with food product 101 to accurately measure its temperature. According to some aspects of this disclosure, sensing device 115 facilitates the determination of the actual (real-time) temperature of feed product 101 at any time during a roasting process rather than an inference of the temperature of food product 101 by proxy. Particularly, sensing probe 115 enables system 100 to provide more accurate temperature determination of food products than conventional food product temperature modification devices.

According to some aspects of this disclosure, data/information collected by the sensing device 112-115 during a roasting process may be used to modify, augment, and/or optimize the roasting process. For example, before illumination of the food product within the enclosed chamber 104, as outgassing of the food product occurs due to being in a vacuum state, pressure levels within the enclosed chamber indicated by the sensing device 112 may be used to adjust the time, temperature, and/or pressure of the roasting process. According to some aspects of this disclosure, constituents of a food product, such as a green coffee bean outgas product and/or the like, may be further analyzed by the control module 102. According to some aspects of this disclosure, the sensing device 112 may include a residual gas analyzer (RGA) to monitor the types and quantities of molecules in the enclosed chamber 104 during a roasting process. The types and quantities of molecules in the enclosed chamber 104 may be provided to the control module 102 and the control module may adjust the operation of one or more components/devices of the system 100 to optimize the roasting process (e.g., increase/decrease illumination by the illuminator 106, modify the agitation rate of the agitation element 108, modify the pressure level by operating the vacuum pump 110, etc.).

As described, according to some aspects of this disclosure, illuminator 106 may be operated to illuminate a food product (e.g., food product 101, etc.) within the enclosed chamber 104. The illuminator 106 may be operated according to lighting attributes (e.g., wavelength values, lumens values, wattage values, etc.) identified for a food product (e.g., based on a processing profile, etc.) to optimize a roasting process. According to some aspects of this disclosure, the control module 102 may identify a pressure level within the enclosed chamber 104 based on information received from the sensing device 112. The control module 102 may send a signal to illuminator 106 to cause the illuminator 106 to modify a lighting attribute of light applied to the food product based on the pressure level. The modified lighting attribute may cause a change to one or more temperatures of a temperature profile (e.g., the temperature of an item at various depths of the item from a surface to a core, etc.) for the food product.

According to some aspects of this disclosure, the control module 102 may receive imaging data (e.g., high-definition imaging depicting a state of a food product, optical pyrometer information, hyperspectral imaging information, speckle field-related information, etc.), for example, from the sensing device 114 indicating the food product. The control module 102 may determine and/or identify from the imaging data that one or more temperatures of the temperature profile (e.g., the temperature of an item at various depths of the item from a surface to a core, etc.) for the food product satisfies a temperature threshold that indicates that the food product is in a particular state (e.g., a first or second crack state for a coffee bean, etc.). Additionally, According to some aspects of this disclosure, a voltage generated by the sensing device 115 due to the temperature of the food product 101 and/or enclosed chamber may be translated into a temperature reading by the control module 102. As described, control module 102 can be interfaced with the heating mechanism (e.g., illuminator 106, heating elements 120, heating element 150, etc.) of enclosed chamber 104, allowing for real-time adjustment of the heating based on the readings.

Additional data/information (e.g., pressure-related information, acoustic/audio information, etc.) from the sensing devices 112-115 may also be used by the control module 102 (e.g., a predictive model of the control module 102, etc.) to identify and/or validate/confirm a state of a food product within the enclosed chamber 104 during a roasting process. According to some aspects of this disclosure, the agitation element 108 may be controllably operated at different rates to agitate the food product and ensure each portion and/or various portions of the food product are identified to be in a user-desired state.

According to some aspects of this disclosure, after a set amount of time (e.g., indicated by a processing profile, etc.), and/or based on the identification and/or determination of a state of a food product within the enclosed chamber 104, the illumination of the food product by the illuminator 106 may be terminated and the agitation rate of the agitator element 108 may be set to a low rate (e.g., 1 RPM, etc.). The throttling valve 118 and/or vacuum pump 110 may be operated to vent the enclosed chamber 104 to an atmospheric pressure level.

According to some aspects of this disclosure, a food product, for example, such as coffee beans, roasted in the enclosed chamber 104 based on illumination from the illuminator 106 that is identified to be in a user-desired state may be removed from the enclosed chamber 104. For example, once roasted, coffee beans may be removed rapidly from the enclosed chamber 104 manually (via a release opening in the enclosed chamber 104 (not shown)) and/or via a suction trap configured with system 100. For example, the computing module 102 may send a signal and/or an instruction to a suction device based on an indication that a food product within the enclosed chamber 104 is in a user-desired state. The signal and/or instruction sent to the suction device that causes the suction device to output may be a suction force that causes the food product to be removed/extracted from the enclosed chamber 104.

FIG. 1B shows an example suction trap of system 100. According to some aspects of this disclosure, system 100 may include a food product trap 130 (e.g., a reservoir, a container, a bagging unit, etc.) and a suction device 132 (e.g., a vacuum device, an air suction pump, etc.). According to some aspects of this disclosure, based on an indication that a food product within the enclosed chamber 104 is in a user-desired state, a pressure level within the enclosed chamber may be equalized to atmospheric pressure based on air inlet to the enclosed chamber via an air inlet valve 134. A food product extraction valve may be opened and the control module 102 may cause the suction device 132 to generate a suction force that forces the food product within the enclosed chamber 104 to be pulled through an opening controlled by a food product evacuation valve 136. The food product falls into the food product trap 130 which may include an inlet for the suction force generated by the suction device 132. A wired mesh and/or the like may cover the inlet to prevent the food product from being pulled outside of the food product trap 130. The food product may cool from a roasting process while inside the food product trap 130.

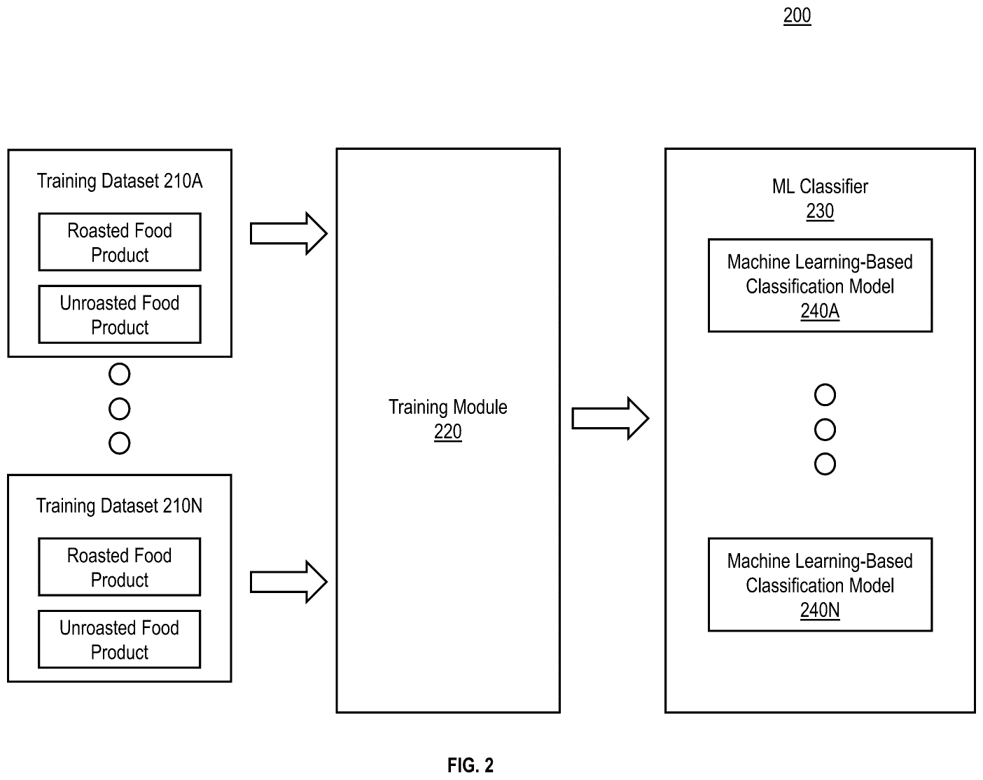

FIG. 2 is an example system 200 for training the control module 102 to manage illumination roasting and/or optimize any roasting process via control of the illuminator 106, vacuum pump 110, the agitation element 106, and/or the like based on data/information received from components of the system 100 including, but not limited to the sensing devices 112-115. FIG. 2 is described with reference to FIG. 1A. According to some aspects of this disclosure, the control module 102 may be trained to determine a roasting state, temperature profile, and/or the like of a food product heated within the enclosed chamber 104. System 200 may use machine learning techniques to train, based on an analysis of one or more training datasets 210A-210N by the control module 102 of FIG. 1A, at least one machine learning-based classifier 230 (e.g., a software model, neural network classification layer, etc.) that is configured to classify features extracted from data/information received from components/devices of the system 100 of FIGS. 1A-1B. The machine learning-based classifier 230 may classify features extracted from data received from the sensing devices 112-115 to identify a food product and determine settings for system 100 to optimize a roasting process for the food product.

One or more training datasets 210A-210N may comprise labeled baseline data such as labeled food product types (e.g., green (unroasted) coffee beans, legumes, meat, grains, etc.), labeled roasting scenarios (e.g., coffee beans in a “first crack” state, coffee beans in a “second crack” state, lighting attributes, pressure conditions within an enclosed chamber, results of roasting different food products under various conditions, etc.), labeled lighting/illumination attribute effects on food products, labeled pressure measurement indicators of food product states and/or pressure-related indicators of food product states, labeled temperature profiles (e.g., the temperature of an item at various depths of the item from a surface to a core, etc.) and related attributes, labeled acoustic indicators of a food product state, and/or the like.

The labeled baseline data may be stored in one or more databases. Data from components/devices of the system 100 indicative of and/or related to a roasting process for a food product may be randomly assigned to a training dataset or a testing dataset. According to some aspects of this disclosure, the assignment of data to a training dataset or a testing dataset may not be completely random. In this case, one or more criteria may be used during the assignment, such as ensuring that similar roasting scenarios, similar lighting/illumination attribute effects on food products, similar pressure-related indicators of food product states, similar temperature profiles and related attributes, similar acoustic indicators of a food product state, dissimilar roasting scenarios, dissimilar lighting/illumination attribute effects on food products, dissimilar pressure-related indicators of food product states, dissimilar temperature profiles and related attributes, dissimilar acoustic indicators of a food product state, and/or the like may be used in each of the training and testing datasets. In general, any suitable method may be used to assign the data to the training or testing datasets.

The control module 102 may train the machine learning-based classifier 230 by extracting a feature set from the labeled baseline data according to one or more feature selection techniques. According to some aspects of this disclosure, the control module 102 may further define the feature set obtained from the labeled baseline data by applying one or more feature selection techniques to the labeled baseline data in one or more training datasets 210A-210N. The control module 102 may extract a feature set from the training datasets 210A-210N in a variety of ways. The control module 102 may perform feature extraction multiple times, each time using a different feature-extraction technique. In some instances, the feature sets generated using the different techniques may each be used to generate different machine learning-based classification models 240. According to some aspects of this disclosure, the feature set with the highest quality metrics may be selected for use in training. The control module 102 may use the feature set(s) to build one or more machine learning-based classification models 240A-240N that are configured to determine and/or predict roasting scenarios, lighting/illumination attribute effects on food products, pressure-related indicators of food product states, temperature profiles and related attributes, acoustic indicators of a food product state, and/or the like.

According to some aspects of this disclosure, the training datasets 210A-210N and/or the labeled baseline data may be analyzed to determine any dependencies, associations, and/or correlations between roasting scenarios, lighting/illumination attribute effects on food products, pressure-related indicators of food product states, temperature profiles and related attributes, acoustic indicators of a food product state, and/or the like in the training datasets 210A-210N and/or the labeled baseline data. The term “feature,” as used herein, may refer to any characteristic of an item of data that may be used to determine whether the item of data falls within one or more specific categories. For example, the features described herein may comprise any data/information that may be used to identify: the moisture content of a food product, a state of the moisture content of a food product during a roasting scenario, the onset of states for food products (e.g., onset indicators of first or second crack states for coffee beans, etc.), and/or the like.

According to some aspects of this disclosure, a feature selection technique may comprise one or more feature selection rules. One or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered candidate features. Any features appearing less than 2 times may be excluded from consideration as a feature. According to some aspects of this disclosure, a single feature selection rule may be applied to select features or multiple feature selection rules may be applied to select features. According to some aspects of this disclosure, the feature selection rules may be applied in a cascading fashion, with the feature selection rules being applied in a specific order and applied to the results of the previous rule. For example, the feature selection rule may be applied to the labeled baseline data to generate information (e.g., an indication of the state of a food product, instructions for modifying a state of a food product according to a heat source and/or enclosure condition, etc.) that may be used for illumination roasting operations for the system 100. A final list of candidate features may be analyzed according to additional features.

According to some aspects of this disclosure, the control module 102 may generate information (e.g., an indication of the state of a food product, instructions for modifying a state of a food product according to a heat source and/or enclosure condition, etc.) that may be used for illumination roasting operations for the system 100 based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects of this disclosure, forward feature selection may be used to identify one or more candidate roasting scenarios, lighting/illumination attribute effects on food products, pressure-related indicators of food product states, temperature profiles and related attributes, acoustic indicators of a food product state, and/or the like. Forward feature selection is an iterative method that begins with no feature in the machine learning model. In each iteration, the feature which best improves the model is added until the addition of a new variable does not improve the performance of the machine learning model. According to some aspects of this disclosure, backward elimination may be used to identify one or more candidate roasting scenarios, lighting/illumination attribute effects on food products, pressure-related indicators of food product states, temperature profiles and related attributes, acoustic indicators of a food product state, and/or the like. Backward elimination is an iterative method that begins with all features in the machine learning model. In each iteration, the least significant feature is removed until no improvement is observed in the removal of features. According to some aspects of this disclosure, recursive feature elimination may be used to identify one or more candidate roasting scenarios, lighting/illumination attribute effects on food products, pressure-related indicators of food product states, temperature profiles and related attributes, acoustic indicators of a food product state, and/or the like. Recursive feature elimination is a greedy optimization algorithm that aims to find the best-performing feature subset. Recursive feature elimination repeatedly creates models and keeps aside the best or the worst-performing feature at each iteration. Recursive feature elimination constructs the next model with the features remaining until all the features are exhausted. Recursive feature elimination then ranks the features based on the order of their elimination.

According to some aspects of this disclosure, one or more candidate roasting scenarios, lighting/illumination attribute effects on food products, pressure-related indicators of food product states, temperature profiles and related attributes, acoustic indicators of a food product state, and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients.

After control module 102 generates a feature set(s), control module 102 may generate a machine learning-based predictive model 240 based on the feature set(s). Machine learning-based predictive models may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects of this disclosure, the control module 102 may use the feature sets extracted from the training datasets 210A-210N and/or the labeled baseline data to build a machine learning-based classification model 240A-240N to determine and/or predict roasting scenarios, lighting/illumination attribute effects on food products, pressure-related indicators of food product states, temperature profiles and related attributes, acoustic indicators of a food product state, and/or the like. According to some aspects of this disclosure, the machine learning-based classification models 240A-240N may be combined into a single machine learning-based classification model 240. Similarly, the machine learning-based classifier 230 may represent a single classifier containing a single or a plurality of machine learning-based classification models 240 and/or multiple classifiers containing a single or a plurality of machine learning-based classification models 240. According to some aspects of this disclosure, the machine learning-based classifier 230 may also include each of the training datasets 210A-210N and/or each feature set extracted from the training datasets 210A-210N and/or extracted from the labeled baseline data. Although shown separately, control module 102 may include the machine learning-based classifier 230.

The extracted features from the data from components/devices of the system 100 may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 230 may comprise a decision rule or a mapping that uses imaging data to determine and/or predict roasting scenarios, lighting/illumination attribute effects on food products, pressure-related indicators of food product states, temperature profiles and related attributes, acoustic indicators of a food product state, and/or the like.

The imaging data and the machine learning-based classifier 230 may be used to determine and/or predict roasting scenarios, lighting/illumination attribute effects on food products, pressure-related indicators of food product states, temperature profiles and related attributes, acoustic indicators of a food product state, and/or the like for the test samples in the test dataset. For example, the result for each test sample may include a confidence level that corresponds to a likelihood or a probability that the corresponding test sample accurately determines and/or predicts roasting scenarios, lighting/illumination attribute effects on food products, pressure-related indicators of food product states, temperature profiles and related attributes, acoustic indicators of a food product state, and/or the like. The confidence level may be a value between zero and one that represents a likelihood that the determined/predicted roasting scenario, lighting/illumination attribute effect on a food product, pressure-related indicator of a food product state, temperature profile and related attribute, acoustic indicator of a food product state, and/or the like is consistent with a computed value. Multiple confidence levels may be provided for each test sample and each candidate (approximated) roasting scenario, lighting/illumination attribute effect on a food product, pressure-related indicator of a food product state, temperature profile and related attribute, acoustic indicator of a food product state, and/or the like. A top-performing candidate roasting scenario, lighting/illumination attribute effect on a food product, pressure-related indicator of a food product state, temperature profile and related attribute, acoustic indicator of a food product state, and/or the like may be determined by comparing the result obtained for each test sample with a computed roasting scenario, lighting/illumination attribute effect on a food product, pressure-related indicator of a food product state, temperature profile and related attribute, acoustic indicator of a food product state, and/or the like for each test sample. In general, the top-performing candidate roasting scenario, lighting/illumination attribute effect on a food product, pressure-related indicator of a food product state, temperature profile and related attribute, acoustic indicator of a food product state, and/or the like will have results that closely match the computed roasting scenario, lighting/illumination attribute effect on a food product, pressure-related indicator of a food product state, temperature profile and related attribute, acoustic indicator of a food product state, and/or the like. The top-performing candidate roasting scenarios, lighting/illumination attribute effects on food products, pressure-related indicators of food product states, temperature profiles and related attributes, acoustic indicators of a food product state, and/or the like may be used for illumination roasting operations.

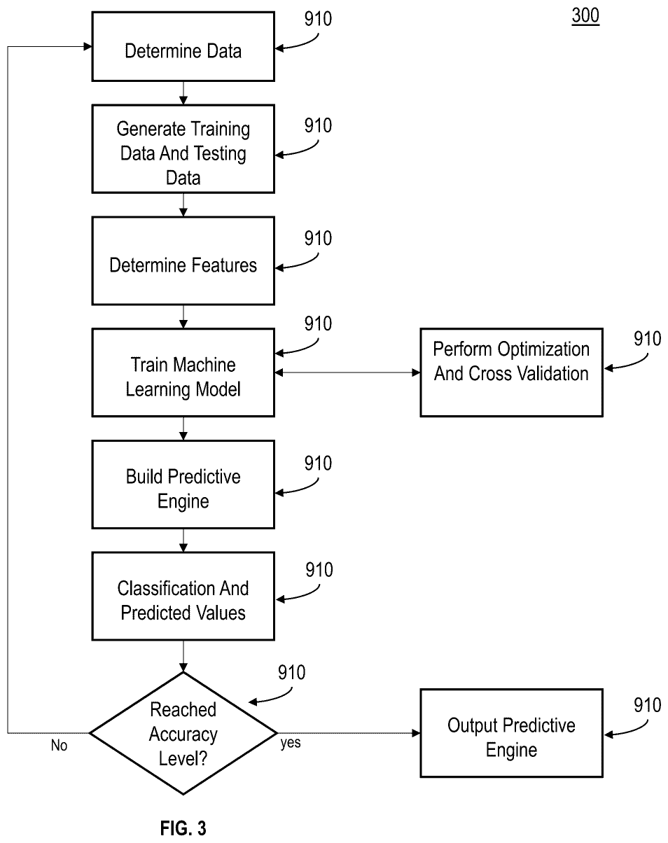

FIG. 3 is a flowchart illustrating an example training method 300 for generating the machine learning classifier 230 using the control module 102, according to some aspects. The control module 102 can implement supervised, unsupervised, and/or semi-supervised (e.g., reinforcement-based) machine learning-based classification models 240. The method 300 shown in FIG. 3 is an example of a supervised learning method; variations of this example of training method are discussed below, however, other training methods can be analogously implemented to train unsupervised and/or semi-supervised machine learning (predictive) models. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to the aspects of those figures.

In 310, control module 102 determines (e.g., accesses, receives, retrieves, etc.) data/information from components/devices of the system 100 indicative of and/or related to a roasting process for a food product. Data/information from components/devices of the system 100 indicative of and/or related to a roasting process for a food product may contain one or more datasets, each dataset associated with a roasting scenario, lighting/illumination attribute effect on a food product, a pressure-related indicator of a food product state, temperature profile and related attribute, acoustic indicator of a food product state, and/or the like.

In 320, control module 102 generates a training dataset and a testing dataset. According to some aspects of this disclosure, the training dataset and the testing dataset may be generated by indicating a roasting scenario, lighting/illumination attribute effect on a food product, a pressure-related indicator of a food product state, temperature profile and related attribute, acoustic indicator of a food product state, and/or the like. According to some aspects of this disclosure, the training dataset and the testing dataset may be generated by randomly assigning a roasting scenario, lighting/illumination attribute effect on a food product, a pressure-related indicator of a food product state, temperature profile and related attribute, acoustic indicator of a food product state, and/or the like to either the training dataset or the testing dataset. According to some aspects of this disclosure, the assignment of imaging data as training or test samples may not be completely random. According to some aspects of this disclosure, only the labeled baseline data for a specific feature extracted from specific sensing device data may be used to generate the training dataset and the testing dataset. According to some aspects of this disclosure, a majority of the labeled baseline data extracted from imaging data may be used to generate the training dataset. For example, 75% of the labeled baseline data for determining a roasting scenario, lighting/illumination attribute effect on a food product, a pressure-related indicator of a food product state, temperature profile and related attribute, acoustic indicator of a food product state, and/or the like extracted from the imaging data may be used to generate the training dataset and 25% may be used to generate the testing dataset. Any method or technique may be used to create the training and testing datasets.

In 330, control module 102 determines (e.g., extract, select, etc.) one or more features that can be used by, for example, a classifier (e.g., a software model, a classification layer of a neural network, etc.) to label features extracted from a variety of data/information from components/devices of the system 100 indicative of and/or related to a roasting process for a food product. One or more features may comprise indications of a roasting scenario, a lighting/illumination attribute effect on a food product, a pressure-related indicator of a food product state, a temperature profile and related attribute, an acoustic indicator of a food product state, and/or the like. According to some aspects of this disclosure, control module 102 may determine a set of training baseline features from the training dataset. Features of imaging data may be determined by any method.

In 340, control module 102 trains one or more machine learning models, for example, using one or more features. According to some aspects of this disclosure, the machine learning models may be trained using supervised learning. According to some aspects of this disclosure, other machine learning techniques may be employed, including unsupervised learning and semi-supervised. The machine learning models trained in 340 may be selected based on different criteria (e.g., how close a predicted roasting scenario, lighting/illumination attribute effect on a food product, a pressure-related indicator of a food product state, temperature profile and related attribute, acoustic indicator of a food product state, and/or the like is to an actual roasting scenario, lighting/illumination attribute effect on a food product, a pressure-related indicator of a food product state, temperature profile and related attribute, acoustic indicator of a food product state, and/or the like, etc.) and/or data available in the training dataset. For example, machine learning classifiers can suffer from different degrees of bias. According to some aspects of this disclosure, more than one machine learning model can be trained.

In 350, control module 102 optimizes, improves, and/or cross-validates trained machine-learning models. For example, data for training datasets and/or testing datasets may be updated and/or revised to include more labeled data indicating different roasting scenarios, lighting/illumination attribute effects on food products, pressure-related indicators of food product states, temperature profiles and related attributes, acoustic indicators of a food product state, and/or the like.

In 360, control module 102 selects one or more machine learning models to build a predictive model (e.g., a machine learning classifier, a predictive engine, etc.). The predictive model may be evaluated using the testing dataset.

In 370, control module 102 executes the predictive model to analyze the testing dataset and generate classification values and/or predicted values.

In 380, control module 102 evaluates classification values and/or predicted values output by the predictive model to determine whether such values have achieved the desired accuracy level. The performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined a roasting scenario, lighting/illumination attribute effect on a food product, pressure-related indicator of a food product state, temperature profile and related attribute, acoustic indicator of a food product state, and/or the like. Conversely, the false negatives of the predictive model may refer to the number of times the machine learning model predicted and/or determined a roasting scenario, lighting/illumination attribute effect on a food product, a pressure-related indicator of a food product state, temperature profile and related attribute, acoustic indicator of a food product state, and/or the like incorrectly, when in fact, the predicted and/or determined a roasting scenario, lighting/illumination attribute effect on a food product, a pressure-related indicator of a food product state, temperature profile and related attribute, acoustic indicator of a food product state, and/or the like matches an actual roasting scenario, lighting/illumination attribute effect on a food product, a pressure-related indicator of a food product state, temperature profile and related attribute, acoustic indicator of a food product state, and/or the like. True negatives and true positives may refer to the number of times the predictive model correctly predicted and/or determined a roasting scenario, lighting/illumination attribute effect on a food product, a pressure-related indicator of a food product state, temperature profile and/or related attribute, acoustic indicator of a food product state, and/or the like. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 390, control module 102 outputs the predictive model (and/or an output of the predictive model). For example, control module 102 may output the predictive model when such a desired accuracy level is reached. An output of the predictive model may end the training phase.

According to some aspects of this disclosure, when the desired accuracy level is not reached, in 390, control module 102 may perform a subsequent iteration of the training method 300 starting at 310 with variations such as, for example, considering a larger collection of data from components/devices of the system 100 indicative of and/or related to a roasting process.

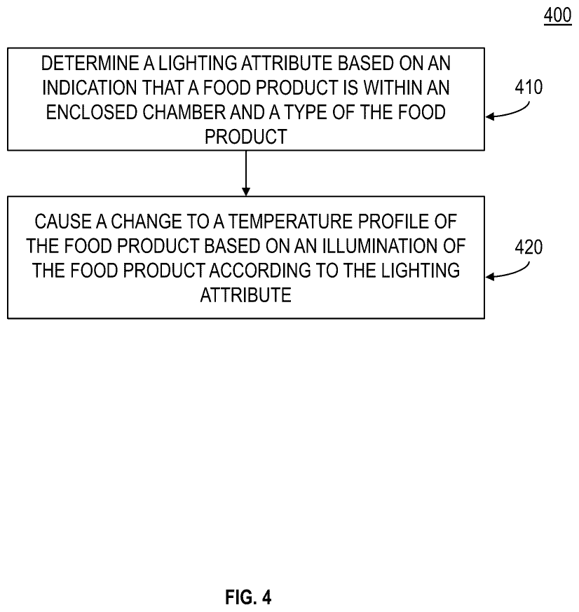

FIG. 4 shows a flowchart of an example method 400 for illumination roasting, according to some aspects. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to the aspects of those figures.

A food product such as coffee roasted under an illumination device while within an enclosed chamber then made immediately ready for grounding and consumption according to the systems, apparatuses, devices, methods, computer program product embodiments, and/or combinations and sub-combinations thereof for illumination roasting described herein.

In 410, control module 102 determines a lighting attribute. According to some aspects of this disclosure, control module 102 determines a lighting attribute based on an indication that a food product is within an enclosed chamber and a type of the food product. According to some aspects of this disclosure, the food product may be unroasted coffee beans. The lighting attribute may be determined, for example, from a look-up table and/or the like that maps types of food products to lighting attributes. The lighting attribute may include a wavelength value, a lumens value, a wattage value, and/or the like. The lighting attribute may be used as an operation setting for an illumination device (e.g., an array of laser diodes, an array of LEDs, an incandescent lamp, a metal halide lamp, arc lamp, etc.) associated it the enclosed chamber. According to some aspects of this disclosure, the enclosed chamber may be a vacuum chamber.

In 420, control module 102 causes a change to a temperature profile of the food product. According to some aspects of this disclosure, control module 102 causes the change to the temperature profile of the food product based on an illumination of the food product according to the lighting attribute. According to some aspects of this disclosure, control module 102 causes the change to the temperature profile of the food product by sending an instruction to an illumination device to illuminate the food product according to the lighting attribute.

According to some aspects of this disclosure, the method 400 may further include control module 102 identifying a pressure level within the enclosed chamber. According to some aspects of this disclosure, control module 102 identifies the pressure level within the enclosed chamber based on information received from a pressure sensing device (e.g, a pressure transducer, etc.) associated with the enclosed chamber. According to some aspects of this disclosure, control module 102 modifies the lighting attribute based on the pressure level. According to some aspects of this disclosure, control module 102 causes a change to another temperature value of the changed temperature profile based on an illumination of the food product according to the modified lighting attribute.

According to some aspects of this disclosure, the method 400 may further include control module 102 causing an agitation element within the enclosed chamber to agitate the food product. According to some aspects of this disclosure, control module 102 causes the agitation element within the enclosed chamber to agitate the food product based on the indication that the food product is within the enclosed chamber. According to some aspects of this disclosure, the agitation rate of the agitation element may be based on a pressure level within the enclosed chamber. According to some aspects of this disclosure, the agitation rate of the agitation element may be based on a temperature of the food product and/or a temperature within the enclosed chamber.

According to some aspects of this disclosure, the method 400 may further include control module 102 identifying (e.g., via computer vision, object recognition, color analysis of an image, etc.) that the food product is in a first state. According to some aspects of this disclosure, control module 102 determines that a temperature value of the changed temperature profile satisfies a temperature threshold that indicates that the food product is in a second state based on image data indicating the food product. According to some aspects of this disclosure, control module 102 causes the food product to be removed from the enclosed chamber based on determining that the temperature value satisfies the temperature threshold. According to some aspects of this disclosure, control module 102 sends an instruction to a suction device to cause the food product to be removed from the enclosed chamber via a suction force generated by the suction device.

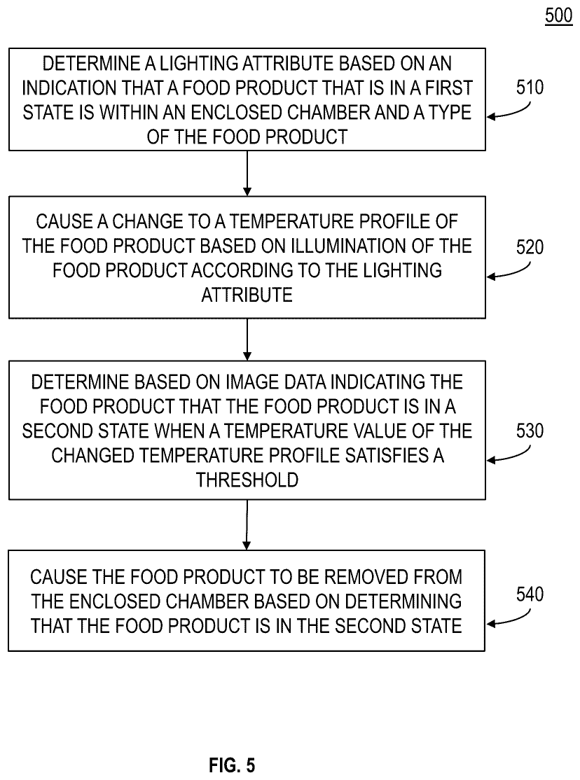

FIG. 5 shows a flowchart of an example method 500 for illumination roasting, according to some aspects. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-3. However, method 500 is not limited to is not limited to the aspects of those figures.

A food product such as coffee roasted under an illumination device while within an enclosed chamber then made immediately ready for grounding and consumption according to the systems, apparatuses, devices, methods, computer program product embodiments, and/or combinations and sub-combinations thereof for illumination roasting described herein.

In 510, control module 102 determines a lighting attribute. According to some aspects of this disclosure, control module 102 determines a lighting attribute based on an indication that a food product is within a vacuum chamber and a type of the food product. According to some aspects of this disclosure, the food product may be unroasted coffee beans. The lighting attribute may be determined, for example, from a look-up table and/or the like that maps types of food products to lighting attributes. The lighting attribute may include a wavelength value, a lumens value, a wattage value, and/or the like. The lighting attribute may be used as an operation setting for an illumination device (e.g., an array of laser diodes, an array of LEDs, an incandescent lamp, metal halide lamp, arc lamp, etc.) associated it the vacuum chamber.

In 520, control module 102 causes a change to a temperature profile of the food product. According to some aspects of this disclosure, control module 102 causes the change to the temperature profile of the food product based on an illumination of the food product according to the lighting attribute. According to some aspects of this disclosure, control module 102 causes the change to the temperature profile of the food product by sending an instruction to an illumination device to illuminate the food product according to the lighting attribute.

In 530, control module 102 determines that a temperature value of the changed temperature profile satisfies a temperature threshold that indicates that the food product is in a second state. According to some aspects of this disclosure, control module 102 determines that the temperature value of the changed temperature profile satisfies the temperature threshold that indicates that the food product is in the second state based on image data indicating the food product.

In 540, control module 102 causes the food product to be removed from the vacuum chamber. According to some aspects of this disclosure, control module 102 causes the food product to be removed from the vacuum chamber based on determining that the temperature value satisfies the temperature threshold. According to some aspects of this disclosure, control module 102 causes the food product to be removed from the enclosed chamber based on determining that the temperature value satisfies the temperature threshold. According to some aspects of this disclosure, control module 102 sends an instruction to a suction device to cause the food product to be removed from the enclosed chamber via a suction force generated by the suction device.

According to some aspects of this disclosure, the method 500 may further include control module 102 identifying a pressure level within the vacuum chamber. According to some aspects of this disclosure, control module 102 identifies the pressure level within the vacuum chamber based on information received from a pressure sensing device (e.g., a pressure transducer, etc.) associated with the vacuum chamber. According to some aspects of this disclosure, control module 102 modifies the lighting attribute based on the pressure level. According to some aspects of this disclosure, control module 102 causes a change to another temperature value of the changed temperature profile based on an illumination of the food product according to the modified lighting attribute.

According to some aspects of this disclosure, the method 500 may further include control module 102 causing an agitation element within the vacuum chamber to agitate the food product. According to some aspects of this disclosure, control module 102 causes the agitation element within the vacuum chamber to agitate the food product based on the indication that the food product is within the vacuum chamber. According to some aspects of this disclosure, the agitation rate of the agitation element may be based on a pressure level within the vacuum chamber. According to some aspects of this disclosure, the agitation rate of the agitation element may be based on a temperature of the food product and/or the temperature within the vacuum chamber.

According to some aspects of this disclosure, method 500 may further include inputting the image data indicating the food product to a predictive model trained to identify a state of a product based on visual attributes of the product. According to some aspects of this disclosure, control module 102 receives an indication that the food product is in the second state based on a color attribute of the food product from the predictive model.

According to some aspects of this disclosure, method 500 may further include initiating a brewing process for the food product. According to some aspects of this disclosure, control module 102 may send one or more signals to a food product brewing device to initiate a brewing process of the food product based on the food product being removed from the vacuum chamber.

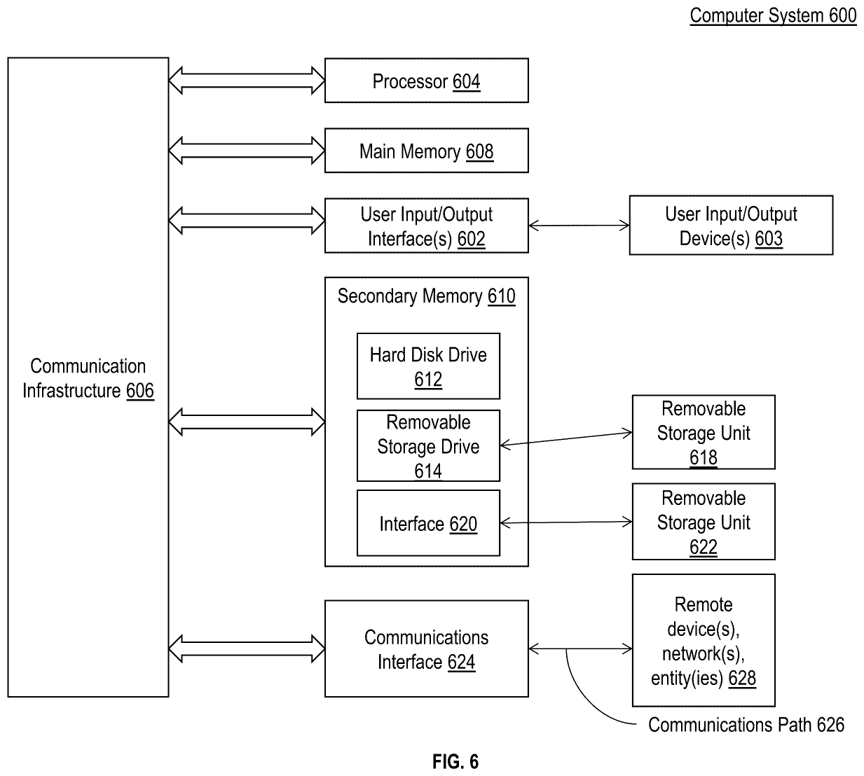

FIG. 6 is an example computer system useful for implementing various embodiments. Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof. According to some aspects of this disclosure, the control module 102 of FIGS. 1A-1B (and/or any other device/component described herein) may be implemented using the computer system 600. According to some aspects of this disclosure, the computer system 600 may be used to implement methods 400 and 500.

Computer system 600 may include one or more processors (also called central processing units, or CPUs), such as a processor 604. Processor 604 may be connected to a communication infrastructure or bus 606.

Computer system 600 may also include user input/output device(s) 602, such as monitors, keyboards, pointing devices, etc., which may communicate with communication infrastructure or bus 606 through user input/output device(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, a tape backup device, and/or any other storage device/drive.

Removable storage drive 614 may interact with a removable storage unit 618. The removable storage unit 618 may include a computer-usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to the removable storage unit 618.

Secondary memory 610 may include other means, devices, components, instrumentalities, and/or other approaches for allowing computer programs and/or other instructions and/or data to be accessed by computer system 600. Such means, devices, components, instrumentalities, and/or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

Example Results of Illumination Roasting

The systems, apparatuses, devices, methods, computer program product embodiments, and/or combinations and sub-combinations thereof for illumination roasting described herein take advantage of the wavelength dependence of the optical absorption property of a food product including, but not limited to, a coffee bean to optimize a roasting process. The systems, apparatuses, devices, methods, computer program product embodiments, and/or combinations and sub-combinations thereof for illumination roasting described herein improve conventional roasting devices and technology by a food product including, but not limited to, a coffee bean from the outside in, with a greater degree of roasting at the surface than the interior of the bean. For example, the systems, apparatuses, devices, methods, computer program product embodiments, and/or combinations and sub-combinations thereof for illumination roasting described herein tailor the wavelength of its light source (e.g., illuminator 106, etc.) to control the heating of a food product with greater precision than in any conventional roasting process. For example, coffee beans have been roasted with a high degree of precisioning of the level of roast (dark roast vs medium roast, for example). The degree of roast of coffee beans can be quantified with the amount of shrinkage, which is the percentage loss of weight of beans after roasting vs prior to roasting. Typical roasters will control the shrinkage to +/−1% (eg, between 14% and 16%) while the processes here have demonstrated control to +/−0.2%.

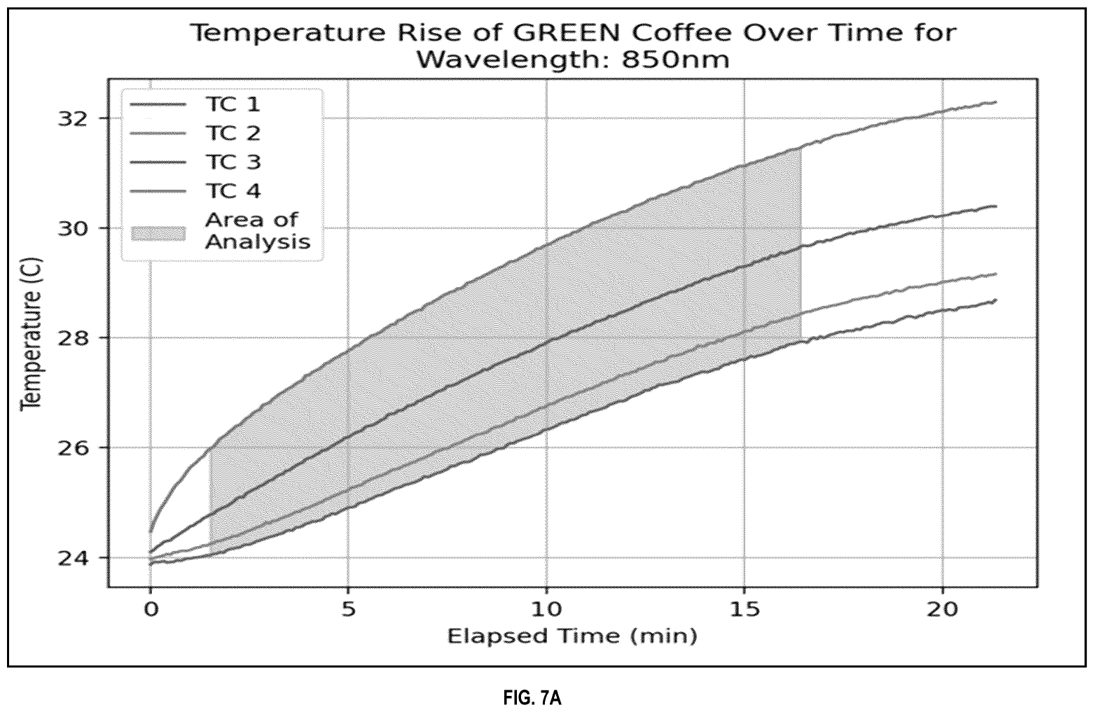

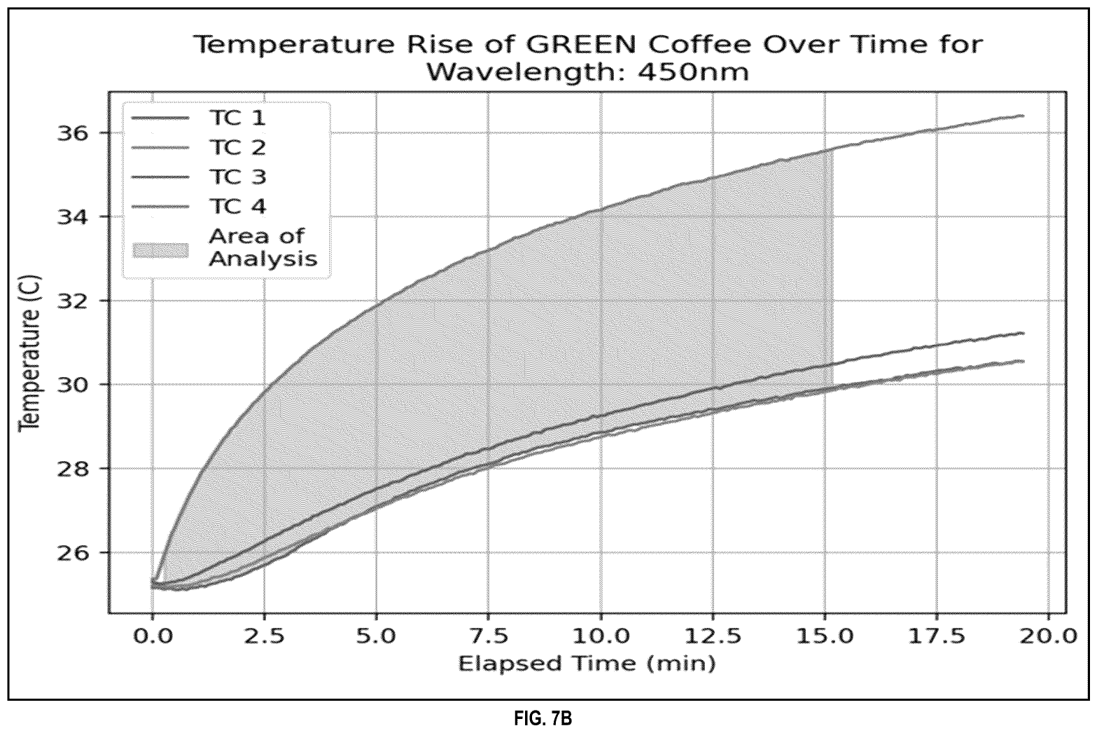

FIGS. 7A-7B show example results of testing system 100 (e.g., results from testing system 100 as depicted in FIG. 1A, as depicted in FIG. 1B, examples of the system 100 with fewer components than depicted in either of FIGS. 1A-1B, and examples of the system 100 with more components than depicted in either of the FIGS. 1A-1B) for illumination roasting of coffee bean granulates (e.g., ground coffee beans) with an initial temperature of the enclosed chamber 104 at 26° C. and the coffee beans exposed to illumination for a minimum of 15 minutes. Sensing devices (e.g., thermocouples) labeled TC 1-TC 2 were used to test the temperature of coffee beans roasted by the system 100 at atmospheric pressure. Sensing device TC 4 was positioned closest to the surface of the coffee, sensing device TC 1 was positioned the farthest from the surface of the coffee beans, and sensing devices TC 2 and TC 3 were positioned at different depths between the locations of TC 1 and TC 2.

FIG. 7A shows results of illumination and/or optical heating and the depth of penetration of the coffee beans with the illuminator 106 set to illuminate the coffee beans at 450 nm wavelength. FIG. 7B shows results of illumination and/or optical heating and the depth of penetration of the coffee beans with the illuminator 106 set to illuminate the coffee beans at 850 nm wavelength.

As shown in FIGS. 7A-7B, light with 450 nm wavelength does not penetrate an unroasted (green) coffee bean as far as light with 850 nm wavelength. However, light with a 450 nm wavelength causes the surface of the unroasted (green) coffee bean to be much hotter (˜36° C. vs ˜32° C. in 15 min). To summarize the results of the testing, the following properties and/or metrics were used in the analysis:
1. Surface Temperature: the final temperature at 15 min of sensing device TC 4 which is an indicator of the surface absorption of the unroasted (green) coffee bean granulate. As depicted, the higher this temperature is, the greater the surface absorption of the light.
2. Delta between the top two sensing devices (e.g., sensing devices TC 4 and TC 3): the difference between t the top two sensing devices at 15 minutes of exposure indicates the optical penetration depth into the unroasted (green) coffee bean granulate. As depicted, the greater this delta is, the greater the surface absorption of the light and the lower the optical penetration into the unroasted (green) coffee bean granulate.
3. Mean Rise: the mean of all sensing devices (e.g., sensing devices TC 1-TC 4) at 15 min minus the mean of all sensing devices at the start of the exposure which indicates the overall heating efficiency of the wavelength of light applied to the coffee bean granulate. As depicted, the greater this value is, the more efficient the optical coupling to the unroasted (green) coffee bean granulate.

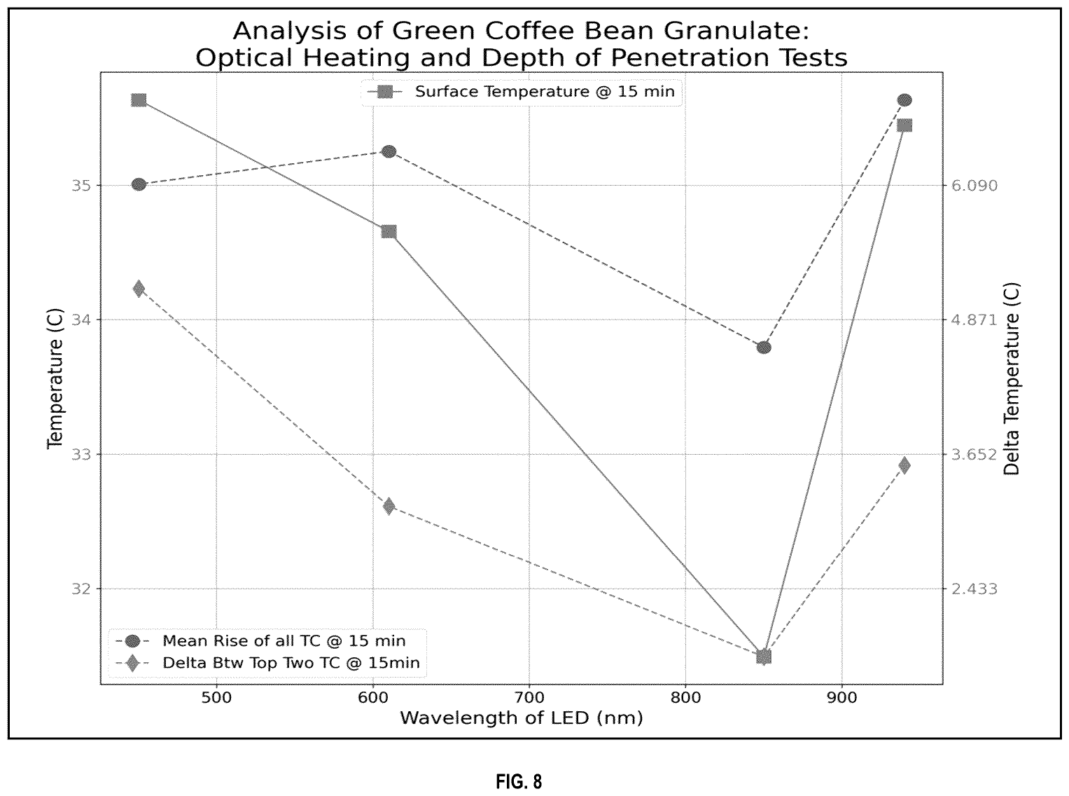

FIG. 8 shows a summary of optical heating and depth penetration tests for unroasted (green) coffee beans at various wavelengths. As shown in FIG. 7, the solid line data corresponds to the left-hand y-axis and the dashed line data corresponds to the right-hand y-axis. As shown in FIG. 7, light emitted at 450 nm wavelength has the highest surface absorption for unroasted (green) coffee beans, light emitted at 950 nm wavelength has a lower surface absorption than light emitted at 450 nm wavelength but was slightly more efficient at heating the sample overall. As shown in FIG. 7, light emitted at 850 nm wavelength has the highest amount of optical penetration, but also the lowest heating efficiency of the wavelengths tested and the lowest surface temperature.

The results in FIG. 8 illustrate the effects of temperature on a sample food product and may be used by the control module 102 to assist the selection of wavelengths for optimizing a roasting process. Other wavelengths may also be used and their optical coupling and penetration characteristics may also be used to optimize a roasting process. In general, one or more wavelengths are desirable with at least one wavelength having a very high surface absorption (such as 450 nm above) and another wavelength having greater optical penetration (such as 940 nm). These wavelengths may then be adjusted during a roasting process to affect the depth of roast of the food product (e.g., coffee bean).

The systems, apparatuses, devices, methods, computer program product embodiments, and/or combinations and sub-combinations thereof for illumination roasting may be applied to any food product including, but not limited to, any coffee bean varietals that may have unique optical characteristics. The systems, apparatuses, devices, methods, computer program product embodiments, and/or combinations and sub-combinations thereof for illumination roasting may optimize a roasting process for any food product including, but not limited to, any coffee bean varietals by matching wavelengths to different food products.

Illumination Roasting at Different Pressures

According to some aspects of this disclosure, the systems, apparatuses, devices, methods, computer program product embodiments, and/or combinations and sub-combinations thereof for illumination roasting incorporate one or more sensing devices including, but not limited to, pressure transducers and/or the like to monitor a roasting process and use data obtained from monitoring the roasting process to optimize the roasting process. According to some aspects of this disclosure, pressure transducers and/or the like, when used in conjunction with a throttling valve (e.g., to control the pumping speed of the enclosed chamber, generate information that may be used to indicate: the moisture content of a food product such as coffee beans before roast; the current state of moisture of the food product during the roast, the onset and/or duration of a state of the food product including, but not limited to, a “first crack” state which indicates a level of roast, and a “second crack” state which indicates the degree of a dark roast.

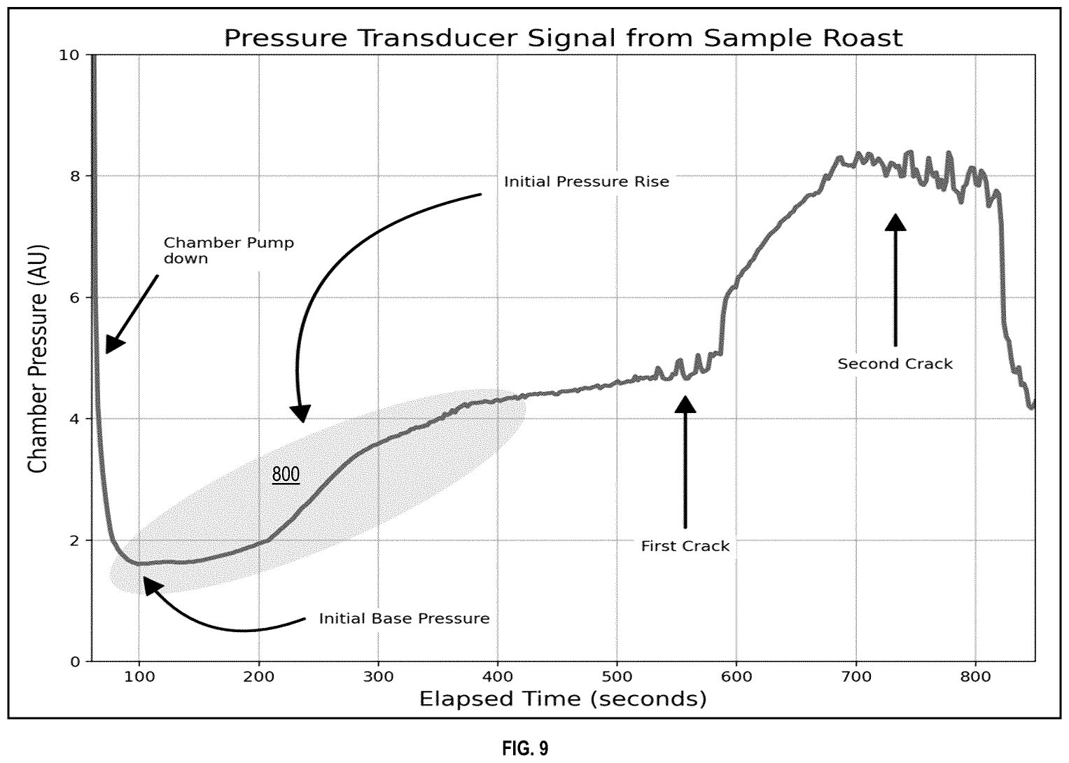

FIG. 9 shows an example output of a sensing device (e.g., the sensing device 112, etc.) of the system 100 during a roasting process. As shown in FIG. 9, the key parts of the sensing device output can be seen to correspond to various parts of a roasting process. According to some aspects of this disclosure, after the enclosed chamber 104 has been pumped down (e.g., via the vacuum pump 110, etc.), a base pressure is reached in the enclosed chamber 104. For a constant chamber pumping speed, this base pressure is related to the outgassing rate of an example food product such as coffee beans during the initial heating, and the outgassing rate is directly related to the moisture level and temperature in the coffee beans. During an initial pressure rise (indicated by oval region 800) in the enclosed chamber 104, the pressure rise occurs as the coffee beans are heated and the outgassing begins to increase. The rate of change of this pressure (i.e. the slope of the line) is also related to the moisture content of the coffee beans. According to some aspects of this disclosure, the control module 102 uses these two initial parts of the signal to optimize the roast by identifying a need for more or less optical power from the illuminator 106 to compensate for the higher or lower moisture content of the coffee beans.

As shown in FIG. 9, the first crack state of the coffee beans starts just before the 500-second mark and indicates the coffee beans reached a sufficient temperature for the water to boil off in the low atmosphere. According to some aspects of this disclosure, this is directly correlated to the “first crack” in a standard roasting process and coffee beans removed at the beginning of this time frame will be a light roast. Coffee beans extracted towards the end of the second crack state (˜580 seconds) were a medium roast. The second crack state is depicted in FIG. 9 to start around 680 seconds and the coffee beans extracted around this time were a dark roast. After about 800 seconds the pressure in the enclosed chamber 104 begins to drop rapidly—all coffee beans are extracted by and/or before this point.

As shown in FIG. 9, using the base pressure and initial pressure rise rate may be used to adjust the optical power of the illuminator 106 to maintain optimal roasting speed independent of the moisture content of the coffee beans. The timing and duration of the first crack state were used to indicate when to terminate a roasting process for either a light or medium roast. The timing and duration of the second crack state were used to indicate when to terminate a roasting process for a dark roast

For one or more embodiments, at least one of the components set forth in one or more of the preceding figures may be configured to perform one or more operations, techniques, processes, and/or methods as set forth in the example section below. For example, the system 100 as described above in connection with one or more of the preceding figures may be configured to operate in accordance with one or more of the examples set forth below.

### Examples

Example 1: A non-transitory computer-readable medium having instructions stored thereon that, when executed by at least one computing device, causes the at least one computing device to perform operations comprising: determining, based on an indication that a food product is within an enclosed chamber and a type of the food product, a lighting attribute; and causing, based on an illumination of the food product according to the lighting attribute, a change to a temperature profile of the food product.

Example 2: The non-transitory computer-readable medium of Example 1, wherein the food product is in a first state, the operations further comprising determining, based on image data indicating the food product, that a temperature value of the changed temperature profile satisfies a temperature threshold that indicates that the food product is in a second state; and causing, based on the determining that the temperature value satisfies the temperature threshold, the food product to be removed from the enclosed chamber.

Example 3: The non-transitory computer-readable any of the preceding examples, wherein the enclosed chamber comprises a vacuum chamber.

Example 4: The non-transitory computer-readable any of the preceding examples, the operations further comprising causing, based on an amount of time for the illumination of the food product according to the lighting attribute satisfying a timing threshold, the food product to be removed from the enclosed chamber.

Example 5: The non-transitory computer-readable any of the preceding examples, wherein the food product comprises at least one of a coffee bean, a legume, a meat, or a grain.

Example 6: The non-transitory computer-readable any of the preceding examples, wherein the causing the change to the temperature profile of the food product comprises sending an instruction to an illumination device to illuminate the food product according to the lighting attribute.

Example 7: The non-transitory computer-readable any of the preceding examples, wherein the illumination device comprises at least one of a laser diode, a light-emitting diode (LED), an incandescent lamp, a metal halide lamp, or an arc lamp.

Example 8: The non-transitory computer-readable any of the preceding examples, wherein the lighting attribute comprises at least one of a wavelength value, a lumens value, or a wattage value.

Example 9: The non-transitory computer-readable any of the preceding examples, the operations further comprising: identifying, based on information received from a pressure sensing device, a pressure level within the enclosed chamber; modifying, based on the pressure level, the lighting attribute; and causing, based on an illumination of the food product according to the modified lighting attribute, a change to another temperature value of the changed temperature profile.

Example 10: The non-transitory computer-readable any of the preceding examples, the operations further comprising causing, based on the indication that the food product is within the enclosed chamber, an agitation element within the enclosed chamber to agitate the food product, wherein the enclosed chamber is a vacuum chamber, and wherein an agitation rate of the agitation element is based on a pressure level within the vacuum chamber.

Example 11: The non-transitory computer-readable any of the preceding examples, the operations further comprising causing, based on the indication that the food product is within the enclosed chamber, an agitation element within the enclosed chamber to agitate the food product, wherein an agitation rate of the agitation element is based on a temperature of the food product.

Example 12: The non-transitory computer-readable any of the preceding examples, the operations further comprising sending an instruction to a suction device to cause the food product to be removed from the enclosed chamber via a suction force generated by the suction device.

Example 13: The non-transitory computer-readable any of the preceding examples, the operations further comprising: inputting, to a predictive model trained to identify a state of a product based on visual attributes of the product, image data indicating the food product; and receiving, from the predictive model, an indication that the food product is in the second state based on a color attribute of the food product.

Example 14: The non-transitory computer-readable any of the preceding examples, wherein the food product is in a first state, the method further comprising: inputting, to a predictive model trained to identify a state of a product based on a type of the product and pressure information indicating an amount of pressure surrounding the product, pressure information indicating an amount of pressure surrounding the food product in the enclosed chamber, and an indication of the food product; and receiving, from the predictive model, an indication that the food product is in a second state.

Example 15: A method of roasting a coffee bean comprising determining, based on an indication that a type of unroasted coffee bean is within an enclosed chamber, a lighting attribute for the type of coffee bean; and transforming, based on an illumination of the unroasted coffee bean according to the lighting attribute, the unroasted coffee bean to a roasted coffee bean.

Example 16: A method of roasting a coffee bean comprising illuminating a coffee bean in an enclosed chamber; receiving, from a first sensing device associated with the enclosed chamber, audio information; determining, based on the audio information, an indication of a state for the coffee bean; determining, based on temperature information received from a second sensing device associated with the enclosed chamber, that a temperature of the coffee beans corresponds to the state for the coffee bean; and terminating, based on the temperature of the coffee beans corresponds to the state for the coffee bean, illumination of the coffee bean.

Example 17: An apparatus comprising: an enclosed chamber configured with an optical window; an illumination element configured to illuminate, via light passing through the optical window, a food product within the enclosed chamber according to a lighting attribute; a pressure sensing device configured to detect a pressure level within the enclosed chamber; an agitation element within the enclosed chamber configured to agitate the food product at a rate determined based on the pressure level within the enclosed chamber; and an optical device configured to capture image data indicative of a temperature profile of the food product within the enclosed chamber.

Example 18: the apparatus of Example 17, wherein the food product comprises at least one of a coffee bean, a legume, a meat, or a grain.

Example 19: the apparatus of Examples 17-18, further comprising at least one heating element external to the enclosed chamber configured to heat the enclosed chamber according to a heating parameter received via a user interface.

Example 20: the apparatus of Examples 17-19, further comprising a pressure control element configured to modify the pressure level within the enclosed chamber, wherein the pressure control element comprises at least one of a vacuum valve, a throttling valve, or a vacuum pump.

Example 21: the apparatus of Examples 17-20, wherein the optical device comprises at least one of an optical pyrometer, a hyperspectral imaging device, or a speckle field detection device.

Example 22: the apparatus of Examples 17-21, further comprising an interactive user interface configured to receive information describing at least one of: a type of the food product within the enclosed chamber, the lighting attribute, or an instruction that causes agitation of the agitation element.

Example 23: the apparatus of Examples 17-22, wherein the illumination element is further configured to illuminate the food product within the enclosed chamber according to another lighting attribute, wherein the another lighting attribute is determined based on information received from the pressure sensing device that indicates the pressure level within the enclosed chamber and information that maps pressure levels to lighting attributes based on food product types.

Example 24: a method comprising: determining, based on an indication that a food product is within an open chamber and a type of the food product, a lighting attribute; and causing, based on an illumination of the food product according to the lighting attribute, a change to a temperature profile of the food product.

Example 25: the method of example 24, wherein the food product is in a first state, the method further comprising determining, based on image data indicating the food product, that a temperature value of the changed temperature profile satisfies a temperature threshold that indicates that the food product is in a second state; and causing, based on the determining that the temperature value satisfies the temperature threshold, the food product to be removed from the open chamber.

Example 26: the method of examples 24-25, wherein the open chamber comprises a vacuum chamber.

Example 27: the method of examples 24-26, further comprising causing, based on an amount of time for the illumination of the food product according to the lighting attribute satisfying a timing threshold, the food product to be removed from the open chamber.

Example 28: the method of examples 24-27, wherein the food product comprises at least one of a coffee bean, a legume, a meat, or a grain.

Example 29: the method of examples 24-28, wherein the causing the change to the temperature profile of the food product comprises sending an instruction to an illumination device to illuminate the food product according to the lighting attribute.

Example 30: the method of example 29, wherein the illumination device comprises at least one of a laser diode, a light-emitting diode (LED), an incandescent lamp, a metal halide lamp, or an arc lamp.

Example 31: the method of examples 24-30, wherein the lighting attribute comprises at least one of a wavelength value, a lumens value, or a wattage value.

Example 32: the method of examples 24-31, further comprising: identifying, based on information received from a pressure sensing device, a pressure level within the open chamber; modifying, based on the pressure level, the lighting attribute; and causing, based on an illumination of the food product according to the modified lighting attribute, a change to another temperature value of the changed temperature profile.

Example 33: the method of examples 24-32, further comprising causing, based on the indication that the food product is within the open chamber, an agitation element within the open chamber to agitate the food product, wherein the open chamber is a vacuum chamber, and wherein an agitation rate of the agitation element is based on a pressure level within the vacuum chamber.

Example 34: the method of examples 24-33, further comprising causing, based on the indication that the food product is within the open chamber, an agitation element within the open chamber to agitate the food product, wherein an agitation rate of the agitation element is based on a temperature of the food product.

Example 35: the method of examples 24-34, further comprising sending an instruction to a suction device to cause the food product to be removed from the open chamber via a suction force generated by the suction device.

Example 36: the method of examples 24-35, further comprising: inputting, to a predictive model trained to identify a state of a product based on visual attributes of the product, image data indicating the food product; and receiving, from the predictive model, an indication that the food product is in the second state based on a color attribute of the food product.

Example 37: the method of examples 24-36, wherein the food product is in a first state, the method further comprising: inputting, to a predictive model trained to identify a state of a product based on a type of the product and pressure information indicating an amount of pressure surrounding the product, pressure information indicating an amount of pressure surrounding the food product in the open chamber, and an indication of the food product; and receiving, from the predictive model, an indication that the food product is in a second state.

Example 38: An apparatus comprising: an enclosed chamber configured with an optical window; an illumination element configured to illuminate, via light passing through the optical window, a food product within the enclosed chamber according to a lighting attribute; a pressure-sensing device configured to detect a pressure level within the enclosed chamber; an agitation element within the enclosed chamber configured to agitate the food product at a rate determined based on the pressure level within the enclosed chamber; and an optical device configured to capture image data indicative of a temperature profile of the food product within the enclosed chamber.

Example 39: the apparatus of Example 38, wherein the food product comprises at least one of a coffee bean, a legume, a meat, or a grain.

Example 40: the apparatus of Examples 38-39, further comprising at least one heating element external to the enclosed chamber configured to heat the enclosed chamber according to a heating parameter received via a user interface.

Example 41: the apparatus of Examples 38-40, further comprising a pressure control element configured to modify the pressure level within the enclosed chamber, wherein the pressure control element comprises at least one of a vacuum valve, a throttling valve, or a vacuum pump.

Example 42: the apparatus of Examples 38-41, wherein the optical device comprises at least one of an optical pyrometer, a hyperspectral imaging device, or a speckle field detection device.

Example 43: the apparatus of Examples 38-42, further comprising an interactive user interface configured to receive information describing at least one of: a type of the food product within the enclosed chamber, the lighting attribute, or an instruction that causes agitation of the agitation element.

Example 44: the apparatus of Examples 38-43, wherein the illumination element is further configured to illuminate the food product within the enclosed chamber according to another lighting attribute, wherein the another lighting attribute is determined based on information received from the pressure sensing device that indicates the pressure level within the enclosed chamber and information that maps pressure levels to lighting attributes based on food product types.

Example 45: the apparatus of Examples 38-44, wherein the illumination element comprises at least one of a laser diode, a light-emitting diode (LED), an incandescent lamp, a metal halide lamp, or an arc lamp.

Example 46: the apparatus of Examples 38-45, further comprising a controller, wherein based on image data indicating the food product received from the optical device, the controller: determines that a temperature value of the temperature profile satisfies a temperature threshold that indicates that the food product changed from a first state to a second state based on illumination from the illumination element; and causes, based on the determination that the temperature value satisfies the temperature threshold, the food product to be removed from the enclosed chamber.

Example 47: the apparatus of Example 46, wherein the controller is further configured with a predictive model trained to identify a state of a product based on a type of the product and pressure information indicating an amount of pressure surrounding the product, wherein the predictive model is configured to: receive an indication of the food product in a first state; and output an indication that the food product is in a second state based on an indication of the pressure level within the enclosed chamber.

Example 48: the apparatus of Examples 38-47, wherein the controller is further configured with a predictive model trained to identify a state of a product based on visual attributes of the product, wherein the predictive model is configured to: receive image data indicating the food product in a first state; and output an indication that the food product is in a second based on a color attribute of the food product.

Example 49: an apparatus comprising: an enclosed chamber configured with an optical window; an illumination element configured to illuminate, via light passing through the optical window, a food product within the enclosed chamber according to a lighting attribute; a pressure-sensing device configured to detect a pressure level within the enclosed chamber; pressure control element configured to modify the pressure level within the enclosed chamber, wherein the pressure control element comprises at least one of a vacuum valve, a throttling valve, or a vacuum pump; an agitation element within the enclosed chamber configured to agitate the food product at a rate determined based on the pressure level within the enclosed chamber; and a temperature sensor configured to detect a temperature profile of the food product within the enclosed chamber.

Example 50: the apparatus of Example 49, wherein the food product comprises at least one of a coffee bean, a legume, a meat, fish, or a grain.

Example 51: the apparatus of Examples 49-50, further comprising at least one heating element within the agitation element configured to heat at least one of the food product or the enclosed chamber according to a heating parameter received via a user interface.

Example 52: the apparatus of Examples 49-51, further comprising an interactive user interface configured to receive information describing at least one of: a type of the food product within the enclosed chamber, the lighting attribute, or an instruction that causes agitation of the agitation element.

Example 53: the apparatus of Examples 49-52, wherein the illumination element is further configured to illuminate the food product within the enclosed chamber according to another lighting attribute, wherein the another lighting attribute is determined based on information received from the pressure-sensing device that indicates the pressure level within the enclosed chamber and information that maps pressure levels to lighting attributes based on food product types.

Example 54: the apparatus of Examples 49-53, further comprising an optical device configured to capture image data indicative of a temperature profile of the food product within the enclosed chamber.

Example 55: the apparatus of Examples 49-54, further comprising a controller, wherein based on image data indicating the food product received from the optical device, the controller: determines that a temperature value of the temperature profile satisfies a temperature threshold that indicates that the food product changed from a first state to a second state based on illumination from the illumination element; and causes, based on the determination that the temperature value satisfies the temperature threshold, the food product to be removed from the enclosed chamber.

Example 56: the apparatus of Examples 49-55, wherein the controller is further configured with a predictive model trained to identify a state of a product based on a type of the product and pressure information indicating an amount of pressure surrounding the product, wherein the predictive model is configured to: receive an indication of the food product in a first state; and output an indication that the food product is in a second state based on an indication of the pressure level within the enclosed chamber.

Example 57: the apparatus of Examples 49-56, wherein the controller is further configured with a predictive model trained to identify a state of a product based on visual attributes of the product, wherein the predictive model is configured to: receive image data indicating the food product in a first state; and output an indication that the food product is in a second based on a color attribute of the food product.

Example 58: An apparatus comprising: a chamber; an illumination element configured to illuminate a food product within the chamber according to a lighting attribute; and an agitation element within the chamber configured to agitate the food product.

Example 59: the apparatus of Example 58, further comprising an optical device configured to capture image data indicative of a temperature profile of the food product within the chamber, wherein the food product comprises at least one of a coffee bean, a nut, a legume, a meat, or a grain.

Example 60: the apparatus of Examples 58-59, wherein the optical device comprises at least one of an optical pyrometer, a hyperspectral imaging device, or a speckle field detection device.

Example 61: the apparatus of Examples 58-60, further comprising at least one heating element external to the chamber configured to heat the chamber according to a heating parameter received via a user interface.

Example 62: the apparatus of Examples 58-61, further comprising: a pressure-sensing device configured to detect a pressure level within the chamber, wherein the agitation element is configured to agitate the food product at a rate determined based on the pressure level within the chamber; and a pressure control element configured to modify the pressure level within the chamber, wherein the pressure control element comprises at least one of a vacuum valve, a throttling valve, or a vacuum pump.

Example 63: the apparatus of Examples 58-62, further comprising an interactive user interface configured to receive information describing at least one of: a type of the food product within the chamber, the lighting attribute, or an instruction that causes agitation of the agitation element.

Example 64: the apparatus of Examples 58-63, wherein the illumination element is further configured to illuminate the food product within the chamber according to another lighting attribute, wherein the another lighting attribute is determined based on information received from a pressure sensing device that indicates a pressure level within the chamber and information that maps pressure levels to lighting attributes based on food product types.

Example 65: the apparatus of Examples 58-64, wherein the illumination element comprises at least one of a laser diode, a light-emitting diode (LED), an incandescent lamp, a metal halide lamp, or an arc lamp.

Example 66: the apparatus of Examples 58-65, further comprising a controller, wherein based on image data indicating the food product received from an optical device, the controller: determines that a temperature value of the temperature profile satisfies a temperature threshold that indicates that the food product changed from a first state to a second state based on illumination from the illumination element; and causes, based on the determination that the temperature value satisfies the temperature threshold, the food product to be removed from the chamber.

Example 67: the apparatus of Example 66, wherein the controller is further configured with a predictive model trained to identify a state of a product based on a type of the product and pressure information indicating an amount of pressure surrounding the product, wherein the predictive model is configured to: receive an indication of the food product in a first state; and output and indication that the food product is in a second state based on an indication of the pressure level within the chamber.

Example 68: the apparatus of Examples 58-67, wherein the controller is further configured with a predictive model trained to identify a state of a product based on visual attributes of the product, wherein the predictive model is configured to: receive image data indicating the food product in a first state; and output and indication that the food product is in a second based on a color attribute of the food product.

Example 69: An apparatus comprising: a chamber; an illumination element configured to illuminate a food product within the chamber according to a lighting attribute; a pressure control element configured to modify a pressure level within the chamber, wherein the pressure control element comprises at least one of a vacuum valve, a throttling valve, or a vacuum pump; and an agitation element within the chamber configured to agitate the food product; and a temperature sensor configured to detect a temperature profile of the food product within the enclosed chamber.

Example 70: the apparatus of Example 69, further comprising a temperature sensor configured to detect a temperature profile of the food product within the chamber, wherein the food product comprises at least one of a coffee bean, an nut, a legume, a meat, or a grain.

Example 71: the apparatus of Examples 69-70, further comprising at least one heating element within the agitation element configured to heat at least one of the food product or the chamber according to a heating parameter received via a user interface.

Example 72: the apparatus of Examples 69-71, further comprising an interactive user interface configured to receive information describing at least one of: a type of the food product within the chamber, the lighting attribute, or an instruction that causes agitation of the agitation element.

Example 73: the apparatus of Examples 69-72, wherein the illumination element is further configured to illuminate the food product within the chamber according to another lighting attribute, wherein the another lighting attribute is determined based on information received from a pressure-sensing device that indicates a pressure level within the chamber and information that maps pressure levels to lighting attributes based on food product types.

Example 74: the apparatus of Examples 69-73, further comprising an optical device configured to capture image data indicative of a temperature profile of the food product within the chamber.

Example 75: the apparatus of Examples 69-74, further comprising a controller, wherein based on image data indicating the food product received from the optical device, the controller: determines that a temperature value of the temperature profile satisfies a temperature threshold that indicates that the food product changed from a first state to a second state based on illumination from the illumination element; and causes, based on the determination that the temperature value satisfies the temperature threshold, the food product to be removed from the chamber.

Example 76: the apparatus of Examples 69-75, wherein the controller is further configured with a predictive model trained to identify a state of a product based on a type of the product and pressure information indicating an amount of pressure surrounding the product, wherein the predictive model is configured to: receive an indication of the food product in a first state; and output and indication that the food product is in a second state based on an indication of the pressure level within the chamber.

Example 77: the apparatus of Examples 69-76, wherein the controller is further configured with a predictive model trained to identify a state of a product based on visual attributes of the product, wherein the predictive model is configured to: receive image data indicating the food product in a first state; and output and indication that the food product is in a second based on a color attribute of the food product.

Example 77: the apparatus of Examples 69-76, wherein the controller is configured with a predictive model trained to identify a state of a product based on a type of the product and temperature information indicating the temperature of the food product by:
receiving an indication of the food product in a first state; and
outputting and indication that the food product is in a second state based on an indication of the temperature profile of the food product.

The breadth and scope of this disclosure should not be limited by any of the above-described aspects, examples, and/or exemplary embodiments, but should be defined only in accordance with the following claims and their equivalents. Those skilled in the art will recognize, or be able to ascertain using no more than routine experimentation, many equivalents to the described aspects, examples, and/or exemplary embodiments described herein. Such equivalents are intended to be encompassed by the following claims.

What is claimed is:

1. An apparatus comprising:
a chamber;
an illumination element configured to illuminate a food product within the chamber according to a lighting attribute; and
an agitation element within the chamber configured to agitate the food product.

2. The apparatus of claim 1, further comprising an optical device configured to capture image data indicative of a temperature profile of the food product within the chamber, wherein the food product comprises at least one of a coffee bean, a nut, a legume, a meat, or a grain.

3. The apparatus of claim 2, wherein the optical device comprises at least one of an optical pyrometer, a hyperspectral imaging device, or a speckle field detection device.

4. The apparatus of claim 1, further comprising at least one heating element external to the chamber configured to heat the chamber according to a heating parameter received via a user interface.

5. The apparatus of claim 1, further comprising:
a pressure-sensing device configured to detect a pressure level within the chamber, wherein the agitation element is configured to agitate the food product at a rate determined based on the pressure level within the chamber; and
a pressure control element configured to modify the pressure level within the chamber, wherein the pressure control element comprises at least one of a vacuum valve, a throttling valve, or a vacuum pump.

6. The apparatus of claim 1, further comprising an interactive user interface configured to receive information describing at least one of: a type of the food product within the chamber, the lighting attribute, or an instruction that causes agitation of the agitation element.

7. The apparatus of claim 1, wherein the illumination element is further configured to illuminate the food product within the chamber according to another lighting attribute, wherein the another lighting attribute is determined based on information received from a pressure sensing device that indicates a pressure level within the chamber and information that maps pressure levels to lighting attributes based on food product types.

8. The apparatus of claim 1, wherein the illumination element comprises at least one of a laser diode, a light-emitting diode (LED), an incandescent lamp, a metal halide lamp, or an arc lamp.

9. The apparatus of claim 1, further comprising a controller, wherein based on image data indicating the food product received from an optical device, the controller:
determines that a temperature value of the temperature profile satisfies a temperature threshold that indicates that the food product changed from a first state to a second state based on illumination from the illumination element; and
causes, based on the determination that the temperature value satisfies the temperature threshold, the food product to be removed from the chamber.

10. The apparatus of claim 9, wherein the controller is further configured with a predictive model trained to identify a state of a product based on a type of the product and pressure information indicating an amount of pressure surrounding the product, wherein the predictive model is configured to:
receive an indication of the food product in a first state; and
output and indication that the food product is in a second state based on an indication of the pressure level within the chamber.

11. The apparatus of claim 9, wherein the controller is further configured with a predictive model trained to identify a state of a product based on visual attributes of the product, wherein the predictive model is configured to:
receive image data indicating the food product in a first state; and
output and indication that the food product is in a second based on a color attribute of the food product.

12. An apparatus comprising:
a chamber;
an illumination element configured to illuminate a food product within the chamber according to a lighting attribute;
a pressure control element configured to modify a pressure level within the chamber, wherein the pressure control element comprises at least one of a vacuum valve, a throttling valve, or a vacuum pump; and
an agitation element within the chamber configured to agitate the food product; and
a temperature sensor configured to detect a temperature profile of the food product within the chamber.

13. The apparatus of claim 12, further comprising a temperature sensor configured to detect a temperature profile of the food product within the chamber, wherein the food product comprises at least one of a coffee bean, an nut, a legume, a meat, or a grain.

14. The apparatus of claim 12, further comprising a controller, wherein the controller is configured with a predictive model trained to identify a state of a product based on a type of the product and temperature information indicating the temperature of the food product by:
receiving an indication of the food product in a first state; and
outputting and indication that the food product is in a second state based on an indication of the temperature profile of the food product.

15. The apparatus of claim 12, further comprising an interactive user interface configured to receive information describing at least one of: a type of the food product within the chamber, the lighting attribute, or an instruction that causes agitation of the agitation element.

16. The apparatus of claim 12, wherein the illumination element is further configured to illuminate the food product within the chamber according to another lighting attribute, wherein the another lighting attribute is determined based on information received from a pressure-sensing device that indicates a pressure level within the chamber and information that maps pressure levels to lighting attributes based on food product types.

17. The apparatus of claim 12, further comprising an optical device configured to capture image data indicative of a temperature profile of the food product within the chamber.

18. The apparatus of claim 12, further comprising a controller, wherein based on image data indicating the food product received from the optical device, the controller:
determines that a temperature value of the temperature profile satisfies a temperature threshold that indicates that the food product changed from a first state to a second state based on illumination from the illumination element; and
causes, based on the determination that the temperature value satisfies the temperature threshold, the food product to be removed from the chamber.

19. The apparatus of claim 18, wherein the controller is further configured with a predictive model trained to identify a state of a product based on a type of the product and pressure information indicating an amount of pressure surrounding the product, wherein the predictive model is configured to:
receive an indication of the food product in a first state; and
output and indication that the food product is in a second state based on an indication of the pressure level within the chamber.

20. The apparatus of claim 18, wherein the controller is further configured with a predictive model trained to identify a state of a product based on visual attributes of the product, wherein the predictive model is configured to:
receive image data indicating the food product in a first state; and
output and indication that the food product is in a second based on a color attribute of the food product.
